(19) United States
(12) Patent Application Publication
(10) Pub. No.: US 2021/0363070 A1
(43) Pub. Date: Nov. 25, 2021

(54) FERTILIZER COMPOSITION

(71) Applicant: ALCOA OF AUSTRALIA LIMITED, Booragoon (AU)

(72) Inventors: Anthony McKinnon, Booragoon (AU); Shani Higginbottom, Booragoon (AU)

(21) Appl. No.: 17/393,086

(22) Filed: Aug. 3, 2021

Related U.S. Application Data
(63) Continuation of application No. PCT/AU2020/050147, filed on Feb. 20, 2020.

(30) Foreign Application Priority Data
Feb. 22, 2019 (AU) 2019900580

(51) Int. Cl. C05C 1/02; C05G 3/00

(52) U.S. Cl. CPC C05C 1/02; C05G 3/00

(57) ABSTRACT

A fertilizer composition comprising an ammonium nitrate material and an effective amount of a stabilizer material to result in a specific impulse reduction of at least 10% when compared the specific impulse of a commercially available ammonium nitrate composition. The stabilizer material may comprise huntite or magnesite. In one embodiment, stabilizer material is about 10 to about 25 wt. % of the total fertilizer composition.

### CROSS-REFERENCE TO RELATED APPLICATIONS

This application is a continuation of International Patent Application No. PCT/AU2020/050147, filed Feb. 20, 2020, which claims priority to Australian Patent Application No. 2019900580, filed Feb. 22, 2019, each of which is incorporated herein by reference in its entirety.

### TECHNICAL FIELD

Generally, the instant disclosure relates to fertilizer compositions and methods of making and using the same. More specifically, the instant disclosure relates to blast suppressant and/or blast resistant ammonium nitrate fertilizer compositions, as well as methods of making and using the same.

### BACKGROUND ART

The following discussion of the background art is intended to facilitate an understanding of the present invention only. The discussion is not an acknowledgement or admission that any of the material referred to is or was part of the common general knowledge as at the priority date of the application.

Ammonium Nitrate (AN) fertilizer, combined with fuel oil (ANFO) or other fuels is a common explosive used throughout the world. Unfortunately, due to the availability of ammonium nitrate and fuels (such as fuel oil, powdered sugar, or aluminium powder), malicious parties (e.g. terrorists) are able to obtain these materials and utilize them in explosives (i.e. bombs and improvised explosive devices).

### SUMMARY OF INVENTION

Various embodiments of the instant disclosure provide for stabilizer materials to ammonium nitrate fertilizer that reduce, prevent, and/or eliminate the unauthorized use of ammonium nitrate to construct ANFO type explosives. Broadly, the instant disclosure is directed towards: fertilizer compositions and methods of making the same, in which, due to the composition, the fertilizer comprises a blast suppression (e.g. measured via specific impulse).

In one aspect of the present invention, a fertilizer composition is provided, comprising: an ammonium nitrate material; and an effective amount of a stabilizer material to result in a specific impulse reduction of at least 10% when compared to the specific impulse of a commercially available ammonium nitrate composition; wherein the stabilizer material comprises huntite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, a fertilizer composition is provided, comprising: an ammonium nitrate material; and an effective amount of a stabilizer material to result in a specific impulse reduction of at least 10% when compared to the specific impulse of a commercially available ammonium nitrate composition; wherein the stabilizer material comprises huntite and wherein the stabilizer material is at least 10 wt. % of the total fertilizer composition.

In one aspect of the present invention, a fertilizer composition is provided, comprising: an ammonium nitrate material; and an effective amount of a stabilizer material to result in a specific impulse reduction of at least 10% when compared to the specific impulse of a commercially available ammonium nitrate composition; wherein the stabilizer material comprises huntite and wherein the stabilizer material is about 10 to about 25 wt. % of the total fertilizer composition.

In one aspect of the present invention, a fertilizer composition is provided, comprising: an ammonium nitrate material; and an effective amount of a stabilizer material to result in a specific impulse reduction of at least 10% when compared to the specific impulse of a commercially available ammonium nitrate composition; wherein the stabilizer material comprises huntite and wherein the stabilizer material is about 10 to about 20 wt. % of the total fertilizer composition.

In one aspect of the present invention, a fertilizer composition is provided, comprising: an ammonium nitrate material; and an effective amount of a stabilizer material to result in a specific impulse reduction of at least 10% when compared to the specific impulse of a commercially available ammonium nitrate composition; wherein the stabilizer material comprises at least 50 wt. % huntite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, a fertilizer composition is provided, comprising: an ammonium nitrate material; and an effective amount of a stabilizer material to result in a specific impulse reduction of at least 10% when compared to the specific impulse of a commercially available ammonium nitrate composition; wherein the stabilizer material comprises at least 50 wt. % huntite and wherein the stabilizer material is at least 10 wt. % of the total fertilizer composition.

In one aspect of the present invention, a fertilizer composition is provided, comprising: an ammonium nitrate material; and an effective amount of a stabilizer material to result in a specific impulse reduction of at least 10% when compared to the specific impulse of a commercially available ammonium nitrate composition; wherein the stabilizer material comprises at least 50 wt. % huntite and wherein the stabilizer material is about 10 wt. % to about 25 wt. % of the total fertilizer composition.

In one aspect of the present invention, a fertilizer composition is provided, comprising: an ammonium nitrate material; and an effective amount of a stabilizer material to result in a specific impulse reduction of at least 10% when compared to the specific impulse of a commercially available ammonium nitrate composition; wherein the stabilizer material comprises at least 50 wt. % huntite and wherein the stabilizer material is about 10 wt. % to about 20 wt. % of the total fertilizer composition.

In one aspect of the present invention, a fertilizer composition is provided, comprising: an ammonium nitrate material; and an effective amount of a stabilizer material to result in a specific impulse reduction of at least 50% when compared to the specific impulse of a commercially available ammonium nitrate composition; wherein the stabilizer material comprises huntite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, a fertilizer composition is provided, comprising: an ammonium nitrate material; and an effective amount of a stabilizer material to result in a specific impulse reduction of at least 50% when compared to the specific impulse of a commercially available ammonium nitrate composition; wherein the stabilizer material comprises huntite and wherein the stabilizer material is at least 10 wt. % of the total fertilizer composition.

In one aspect of the present invention, a fertilizer composition is provided, comprising: an ammonium nitrate material; and an effective amount of a stabilizer material to result in a specific impulse reduction of at least 50% when compared to the specific impulse of a commercially available ammonium nitrate composition; wherein the stabilizer material comprises huntite and wherein the stabilizer material is about 10 wt. % to about 25 wt. % of the total fertilizer composition.

In one aspect of the present invention, a fertilizer composition is provided, comprising: an ammonium nitrate material; and an effective amount of a stabilizer material to result in a specific impulse reduction of at least 50% when compared to the specific impulse of a commercially available ammonium nitrate composition; wherein the stabilizer material comprises huntite and wherein the stabilizer material is about 10 wt. % to about 20 wt. % of the total fertilizer composition.

In one aspect of the present invention, a fertilizer composition is provided, comprising: an ammonium nitrate material; and an effective amount of a stabilizer material to result in a specific impulse reduction of at least 80% when compared to the specific impulse of a commercially available ammonium nitrate composition; wherein the stabilizer material comprises huntite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, a fertilizer composition is provided, comprising: an ammonium nitrate material; and an effective amount of a stabilizer material to result in a specific impulse reduction of at least 80% when compared to the specific impulse of a commercially available ammonium nitrate composition; wherein the stabilizer material comprises huntite and wherein the stabilizer material is at least 10 wt. % of the total fertilizer composition.

In one aspect of the present invention, a fertilizer composition is provided, comprising: an ammonium nitrate material; and an effective amount of a stabilizer material to result in a specific impulse reduction of at least 80% when compared to the specific impulse of a commercially available ammonium nitrate composition; wherein the stabilizer material comprises huntite and wherein the stabilizer material is about 10 wt. % to about 25 wt. % of the total fertilizer composition.

In one aspect of the present invention, a fertilizer composition is provided, comprising: an ammonium nitrate material; and an effective amount of a stabilizer material to result in a specific impulse reduction of at least 80% when compared to the specific impulse of a commercially available ammonium nitrate composition; wherein the stabilizer material comprises huntite and wherein the stabilizer material is about 10 wt. % to about 20 wt. % of the total fertilizer composition.

In one aspect of the present invention, a fertilizer composition is provided, comprising: an ammonium nitrate material; and an effective amount of a stabilizer material to result in a specific impulse reduction of at least 90% when compared to the specific impulse of a commercially available ammonium nitrate composition; wherein the stabilizer material comprises huntite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, a fertilizer composition is provided, comprising: an ammonium nitrate material; and an effective amount of a stabilizer material to result in a specific impulse reduction of at least 90% when compared to the specific impulse of a commercially available ammonium nitrate composition; wherein the stabilizer material comprises huntite and wherein the stabilizer material is at least 10 wt. % of the total fertilizer composition.

In one aspect of the present invention, a fertilizer composition is provided, comprising: an ammonium nitrate material; and an effective amount of a stabilizer material to result in a specific impulse reduction of at least 90% when compared to the specific impulse of a commercially available ammonium nitrate composition; wherein the stabilizer material comprises huntite and wherein the stabilizer material is about 10 wt. % to about 25 wt. % of the total fertilizer composition.

In one aspect of the present invention, a fertilizer composition is provided, comprising: an ammonium nitrate material; and an effective amount of a stabilizer material to result in a specific impulse reduction of at least 90% when compared to the specific impulse of a commercially available ammonium nitrate composition; wherein the stabilizer material comprises huntite and wherein the stabilizer material is about 10 wt. % to about 20 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 10% when compared to the specific impulse of a commercially available ammonium nitrate composition; wherein the stabilizer material comprises huntite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 10% when compared to the specific impulse of a commercially available ammonium nitrate composition; wherein the stabilizer material comprises huntite and wherein the stabilizer material is at least 10 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 10% when compared to the specific impulse of a commercially available ammonium nitrate composition; wherein the stabilizer material comprises huntite and wherein the stabilizer material is about 10 wt. % to about 25 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 10% when compared to the specific impulse of a commercially available ammonium nitrate composition; wherein the stabilizer material comprises huntite and wherein the stabilizer material is about 10 wt. % to about 20 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 10% when compared to the specific impulse of a commercially available ammonium nitrate composition; wherein the stabilizer material comprises at least 50 wt. % huntite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 10% when compared to the specific impulse of a commercially available ammonium nitrate composition; wherein the stabilizer material comprises at least 50 wt. % huntite and wherein the stabilizer material is at least 10 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 10% when compared to the specific impulse of a commercially available ammonium nitrate composition; wherein the stabilizer material comprises at least 50 wt. % huntite and wherein the stabilizer material is about 10 wt. % to about 25 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 10% when compared to the specific impulse of a commercially available ammonium nitrate composition; wherein the stabilizer material comprises at least 50 wt. % huntite and wherein the stabilizer material is about 10 wt. % to about 20 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 50% when compared to the specific impulse of a commercially available ammonium nitrate composition; wherein the stabilizer material comprises huntite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 50% when compared to the specific impulse of a commercially available ammonium nitrate composition; wherein the stabilizer material comprises huntite and wherein the stabilizer material is at least 10 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 50% when compared to the specific impulse of a commercially available ammonium nitrate composition; wherein the stabilizer material comprises huntite and wherein the stabilizer material is about 10 wt. % to about 25 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 50% when compared to the specific impulse of a commercially available ammonium nitrate composition; wherein the stabilizer material comprises huntite and wherein the stabilizer material is about 10 wt. % to about 20 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 80% when compared to the specific impulse of a commercially available ammonium nitrate composition; wherein the stabilizer material comprises huntite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 80% when compared to the specific impulse of a commercially available ammonium nitrate composition; wherein the stabilizer material comprises huntite and wherein the stabilizer material is at least 10 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 80% when compared to the specific impulse of a commercially available ammonium nitrate composition; wherein the stabilizer material comprises huntite and wherein the stabilizer material is about 10 wt. % to about 25 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 80% when compared to the specific impulse of a commercially available ammonium nitrate composition; wherein the stabilizer material comprises huntite and wherein the stabilizer material is about 10 wt. % to about 20 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 90% when compared to the specific impulse of a commercially available ammonium nitrate composition; wherein the stabilizer material comprises huntite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 90% when compared to the specific impulse of a commercially available ammonium nitrate composition; wherein the stabilizer material comprises huntite and wherein the stabilizer material is at least 10 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 90% when compared to the specific impulse of a commercially available ammonium nitrate composition; wherein the stabilizer material comprises huntite and wherein the stabilizer material is about 10 wt. % to about 25 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 90% when compared to the specific impulse of a commercially available ammonium nitrate composition; wherein the stabilizer material comprises huntite and wherein the stabilizer material is about 10 wt. % to about 20 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 10% less than the specific impulse of a commercially available ammonium nitrate composition; wherein the stabilizer material comprises huntite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 10% less than the specific impulse of a commercially available ammonium nitrate composition; wherein the stabilizer material comprises huntite and wherein the stabilizer material is at least 10 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 10% less than the specific impulse of a commercially available ammonium nitrate composition; wherein the stabilizer material comprises huntite and wherein the stabilizer material is about 10 wt. % to about 25 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 10% less than the specific impulse of a commercially available ammonium nitrate composition; wherein the stabilizer material comprises huntite and wherein the stabilizer material is about 10 wt. % to about 20 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 10% less than the specific impulse of a commercially available ammonium nitrate composition; wherein the stabilizer material comprises at least 50 wt. % huntite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 10% less than the specific impulse of a commercially available ammonium nitrate composition; wherein the stabilizer material comprises at least 50 wt. % huntite and wherein the stabilizer material is at least 10 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 10% less than the specific impulse of a commercially available ammonium nitrate composition; wherein the stabilizer material comprises at least 50 wt. % huntite and wherein the stabilizer material is about 10 wt. % to about 25 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 10% less than the specific impulse of a commercially available ammonium nitrate composition; wherein the stabilizer material comprises at least 50 wt. % huntite and wherein the stabilizer material is about 10 to about 20 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 50% less than the specific impulse of a commercially available ammonium nitrate composition; wherein the stabilizer material comprises huntite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 50% less than the specific impulse of a commercially available ammonium nitrate composition; wherein the stabilizer material comprises huntite and wherein the stabilizer material is at least 10 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 50% less than the specific impulse of a commercially available ammonium nitrate composition; wherein the stabilizer material comprises huntite and wherein the stabilizer material is about 10 wt. % to about 25 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 50% less than the specific impulse of a commercially available ammonium nitrate composition; wherein the stabilizer material comprises huntite and wherein the stabilizer material is about 10 wt. % to about 20 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 80% less than the specific impulse of a commercially available ammonium nitrate composition; wherein the stabilizer material comprises huntite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 80% less than the specific impulse of a commercially available ammonium nitrate composition; wherein the stabilizer material comprises huntite and wherein the stabilizer material is at least 10 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 80% less than the specific impulse of a commercially available ammonium nitrate composition; wherein the stabilizer material comprises huntite and wherein the stabilizer material is about 10 wt. % to about 25 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 80% less than the specific impulse of a commercially available ammonium nitrate composition; wherein the stabilizer material comprises huntite and wherein the stabilizer material is about 10 wt. % to about 20 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 90% less than the specific impulse of a commercially available ammonium nitrate composition; wherein the stabilizer material comprises huntite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 90% less than the specific impulse of a commercially available ammonium nitrate composition; wherein the stabilizer material comprises huntite and wherein the stabilizer material is at least 10 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 90% less than the specific impulse of a commercially available ammonium nitrate composition; wherein the stabilizer material comprises huntite and wherein the stabilizer material is about 10 wt. % to about 25 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 90% less than the specific impulse of a commercially available ammonium nitrate composition; wherein the stabilizer material comprises huntite and wherein the stabilizer material is about 10 wt. % to about 20 wt. % of the total fertilizer composition.

In one aspect of the present invention, there is provided a method for the use of a stabilizer material for the preparation of an ammonium nitrate fertilizer composition, wherein the fertilizer composition comprises an effective amount of a stabilizer material to result in a specific impulse reduction of at least 10% when compared to the specific impulse of a commercially available ammonium nitrate composition; wherein the stabilizer material comprises huntite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, there is provided a method for the use of a stabilizer material for the preparation of an ammonium nitrate fertilizer composition, wherein the fertilizer composition comprises an effective amount of a stabilizer material to result in a specific impulse reduction of at least 10% when compared to the specific impulse of a commercially available ammonium nitrate composition; wherein the stabilizer material comprises huntite and wherein the stabilizer material is at least 10 wt. % of the total fertilizer composition.

In one aspect of the present invention, there is provided a method for the use of a stabilizer material for the preparation of an ammonium nitrate fertilizer composition, wherein the fertilizer composition comprises an effective amount of a stabilizer material to result in a specific impulse reduction of at least 10% when compared to the specific impulse of a commercially available ammonium nitrate composition; wherein the stabilizer material comprises huntite and wherein the stabilizer material is about 10 wt. % to about 25 wt. % of the total fertilizer composition.

In one aspect of the present invention, there is provided a method for the use of a stabilizer material for the preparation of an ammonium nitrate fertilizer composition, wherein the fertilizer composition comprises an effective amount of a stabilizer material to result in a specific impulse reduction of at least 10% when compared to the specific impulse of a commercially available ammonium nitrate composition; wherein the stabilizer material comprises huntite and wherein the stabilizer material is about 10 wt. % to about 20 wt. % of the total fertilizer composition.

In one aspect of the present invention, there is provided a method for the use of a stabilizer material for the preparation of an ammonium nitrate fertilizer composition, wherein the fertilizer composition comprises an effective amount of a stabilizer material to result in a specific impulse reduction of at least 10% when compared to the specific impulse of a commercially available ammonium nitrate composition; wherein the stabilizer material comprises at least 50 wt. % huntite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, there is provided a method for the use of a stabilizer material for the preparation of an ammonium nitrate fertilizer composition, wherein the fertilizer composition comprises an effective amount of a stabilizer material to result in a specific impulse reduction of at least 10% when compared to the specific impulse of a commercially available ammonium nitrate composition; wherein the stabilizer material comprises at least 50 wt. % huntite and wherein the stabilizer material is at least 10 wt. % of the total fertilizer composition.

In one aspect of the present invention, there is provided a method for the use of a stabilizer material for the preparation of an ammonium nitrate fertilizer composition, wherein the fertilizer composition comprises an effective amount of a stabilizer material to result in a specific impulse reduction of at least 10% when compared to the specific impulse of a commercially available ammonium nitrate composition; wherein the stabilizer material comprises at least 50 wt. % huntite and wherein the stabilizer material is about 10 wt. % to about 25 wt. % of the total fertilizer composition.

In one aspect of the present invention, there is provided a method for the use of a stabilizer material for the preparation of an ammonium nitrate fertilizer composition, wherein the fertilizer composition comprises an effective amount of a stabilizer material to result in a specific impulse reduction of at least 10% when compared to the specific impulse of a commercially available ammonium nitrate composition; wherein the stabilizer material comprises at least 50 wt. % huntite and wherein the stabilizer material is about 10 wt. % to about 20 wt. % of the total fertilizer composition.

In one aspect of the present invention, there is provided a method for the use of a stabilizer material for the preparation of an ammonium nitrate fertilizer composition, wherein the fertilizer composition comprises an effective amount of a stabilizer material to result in a specific impulse reduction of at least 50% when compared to the specific impulse of a commercially available ammonium nitrate composition; wherein the stabilizer material comprises huntite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, there is provided a method for the use of a stabilizer material for the preparation of an ammonium nitrate fertilizer composition, wherein the fertilizer composition comprises an effective amount of a stabilizer material to result in a specific impulse reduction of at least 50% when compared to the specific impulse of a commercially available ammonium nitrate composition; wherein the stabilizer material comprises huntite and wherein the stabilizer material is at least 10 wt. % of the total fertilizer composition.

In one aspect of the present invention, there is provided a method for the use of a stabilizer material for the preparation of an ammonium nitrate fertilizer composition, wherein the fertilizer composition comprises an effective amount of a stabilizer material to result in a specific impulse reduction of at least 50% when compared to the specific impulse of a commercially available ammonium nitrate composition; wherein the stabilizer material comprises huntite and wherein the stabilizer material is about 10 wt. % to about 25 wt. % of the total fertilizer composition.

In one aspect of the present invention, there is provided a method for the use of a stabilizer material for the preparation of an ammonium nitrate fertilizer composition, wherein the fertilizer composition comprises an effective amount of a stabilizer material to result in a specific impulse reduction of at least 50% when compared to the specific impulse of a commercially available ammonium nitrate composition; wherein the stabilizer material comprises huntite and wherein the stabilizer material is about 10 wt. % to about 20 wt. % of the total fertilizer composition.

In one aspect of the present invention, there is provided a method for the use of a stabilizer material for the preparation of an ammonium nitrate fertilizer composition, wherein the fertilizer composition comprises an effective amount of a stabilizer material to result in a specific impulse reduction of at least 80% when compared to the specific impulse of a commercially available ammonium nitrate composition; wherein the stabilizer material comprises huntite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, there is provided a method for the use of a stabilizer material for the preparation of an ammonium nitrate fertilizer composition, wherein the fertilizer composition comprises an effective amount of a stabilizer material to result in a specific impulse reduction of at least 80% when compared to the specific impulse of a commercially available ammonium nitrate composition; wherein the stabilizer material comprises huntite and wherein the stabilizer material is at least 10 wt. % of the total fertilizer composition.

In one aspect of the present invention, there is provided a method for the use of a stabilizer material for the preparation of an ammonium nitrate fertilizer composition, wherein the fertilizer composition comprises an effective amount of a stabilizer material to result in a specific impulse reduction of at least 80% when compared to the specific impulse of a commercially available ammonium nitrate composition; wherein the stabilizer material comprises huntite and wherein the stabilizer material is about 10 wt. % to about 25 wt. % of the total fertilizer composition.

In one aspect of the present invention, there is provided a method for the use of a stabilizer material for the preparation of an ammonium nitrate fertilizer composition, wherein the fertilizer composition comprises an effective amount of a stabilizer material to result in a specific impulse reduction of at least 80% when compared to the specific impulse of a commercially available ammonium nitrate composition; wherein the stabilizer material comprises huntite and wherein the stabilizer material is about 10 wt. % to about 20 wt. % of the total fertilizer composition.

In one aspect of the present invention, there is provided a method for the use of a stabilizer material for the preparation of an ammonium nitrate fertilizer composition, wherein the fertilizer composition comprises an effective amount of a stabilizer material to result in a specific impulse reduction of at least 90% when compared to the specific impulse of a commercially available ammonium nitrate composition; wherein the stabilizer material comprises huntite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, there is provided a method for the use of a stabilizer material for the preparation of an ammonium nitrate fertilizer composition, wherein the fertilizer composition comprises an effective amount of a stabilizer material to result in a specific impulse reduction of at least 90% when compared to the specific impulse of a commercially available ammonium nitrate composition; wherein the stabilizer material comprises huntite and wherein the stabilizer material is at least 10 wt. % of the total fertilizer composition.

In one aspect of the present invention, there is provided a method for the use of a stabilizer material for the preparation of an ammonium nitrate fertilizer composition, wherein the fertilizer composition comprises an effective amount of a stabilizer material to result in a specific impulse reduction of at least 90% when compared to the specific impulse of a commercially available ammonium nitrate composition; wherein the stabilizer material comprises huntite and wherein the stabilizer material is about 10 wt. % to about 25 wt. % of the total fertilizer composition.

In one aspect of the present invention, there is provided a method for the use of a stabilizer material for the preparation of an ammonium nitrate fertilizer composition, wherein the fertilizer composition comprises an effective amount of a stabilizer material to result in a specific impulse reduction of at least 90% when compared to the specific impulse of a commercially available ammonium nitrate composition; wherein the stabilizer material comprises huntite and wherein the stabilizer material is about 10 wt. % to about 20 wt. % of the total fertilizer composition.

In one embodiment, the stabilizer material further comprises hydromagnesite.

In one embodiment, the stabilizer material further comprises calcium carbonate.

In one embodiment, the stabilizer material comprises huntite, hydromagnesite and calcium carbonate.

As used herein, “huntite” means a carbonate mineral. The formula of huntite may be represented as Mg₃Ca(CO₃)_{4,} although it will be appreciated that variations on this formula may still describe huntites.

As used herein, “hydromagnesite” is a magnesium carbonate. The formula of hydromagnesite may be represented as Mg₅(CO₃)₄(OH)₂·4H₂₀, although it will be appreciated that variations on this formula may still describe hydromagnesites.

In one embodiment of the present invention, the stabilizer material comprises at least 10 wt. % huntite. In an alternate embodiment, the stabilizer comprises at least 20 wt. % huntite. In an alternate embodiment, the stabilizer comprises at least 30 wt. % huntite. In an alternate embodiment, the stabilizer comprises at least 40 wt. % huntite. In an alternate embodiment, the stabilizer comprises at least 50 wt. % huntite. In an alternate embodiment, the stabilizer comprises at least 60 wt. % huntite. In an alternate embodiment, the stabilizer comprises at least 70 wt. % huntite. In an alternate embodiment, the stabilizer comprises at least 80 wt. % huntite. In an alternate embodiment, the stabilizer comprises at least 90 wt. % huntite.

In one embodiment of the present invention, the stabilizer material comprises between 50 wt. % and 90 wt. % huntite. In an alternate embodiment, the stabilizer material comprises between 50 wt. % and 80 wt. % huntite. In an alternate embodiment, the stabilizer material comprises between 50 wt. % and 70 wt. % huntite. In an alternate embodiment, the stabilizer material comprises between 50 wt. % and 60 wt. % huntite. In an alternate embodiment, the stabilizer material comprises between 60 wt. % and 90 wt. % huntite. In an alternate embodiment, the stabilizer material comprises between 60 wt. % and 80 wt. % huntite. In an alternate embodiment, the stabilizer material comprises between 60 wt. % and 70 wt. % huntite. In an alternate embodiment, the stabilizer material comprises between 70 wt. % and 90 wt. % huntite. In an alternate embodiment, the stabilizer material comprises between 70 wt. % and 80 wt. % huntite. In an alternate embodiment, the stabilizer material comprises between 80 wt. % and 90 wt. % huntite.

In one embodiment of the present invention, the stabilizer material comprises at least 1 wt. % hydromagnesite. In an alternate embodiment, the stabilizer comprises at least 5 wt. % hydromagnesite. In an alternate embodiment, the stabilizer comprises at least 10 wt. % hydromagnesite. In an alternate embodiment, the stabilizer comprises at least 20 wt. % hydromagnesite. In an alternate embodiment, the stabilizer comprises at least 30 wt. % hydromagnesite. In an alternate embodiment, the stabilizer comprises at least 40 wt. % hydromagnesite. In an alternate embodiment, the stabilizer comprises at least 50 wt. % hydromagnesite. In an alternate embodiment, the stabilizer comprises at least 60 wt. % hydromagnesite. In an alternate embodiment, the stabilizer comprises at least 70 wt. % hydromagnesite. In an alternate embodiment, the stabilizer comprises at least 80 wt. % hydromagnesite. In an alternate embodiment, the stabilizer comprises at least 90 wt. % hydromagnesite.

In one embodiment of the present invention, the stabilizer material comprises between 1 wt. % and 40 wt. % hydromagnesite. In an alternate embodiment, the stabilizer comprises between 10 wt. % and 40 wt. % hydromagnesite. In an alternate embodiment, the stabilizer comprises between 20 wt. % and 40 wt. % hydromagnesite. In an alternate embodiment, the stabilizer comprises between 30 wt. % and 40 wt. % hydromagnesite. In an alternate embodiment, the stabilizer comprises between 1 wt. % and 30 wt. % hydromagnesite. In an alternate embodiment, the stabilizer comprises between 10 wt. % and 30 wt. % hydromagnesite. In an alternate embodiment, the stabilizer comprises between 20 wt. % and 30 wt. % hydromagnesite. In an alternate embodiment, the stabilizer comprises between 1 wt. % and 20 wt. % hydromagnesite. In an alternate embodiment, the stabilizer comprises between 10 wt. % and 20 wt. % hydromagnesite.

In one embodiment of the present invention, the stabilizer material comprises between 1 wt. % and 30 wt. % calcium carbonate. In an alternate embodiment, the stabilizer material comprises between 1 wt. % and 20 wt. % calcium carbonate. In an alternate embodiment, the stabilizer material comprises between 1 wt. % and 10 wt. % calcium carbonate. In an alternate embodiment, the stabilizer material comprises between 10 wt. % and 30 wt. % calcium carbonate. In an alternate embodiment, the stabilizer material comprises between 10 wt. % and 20 wt. % calcium carbonate. In an alternate embodiment, the stabilizer material comprises between 20 wt. % and 30 wt. % calcium carbonate.

In one embodiment, the stabilizer material comprises trace amounts of calcium carbonate.

In one embodiment, the stabilizer material comprises between 10 wt. % and 90 wt. % huntite, between 1 wt. % and 90 wt. % hydromagnesite and between 1 wt. % and 90 wt. % calcium carbonate. In an alternate embodiment, the stabilizer material comprises between 50 wt. % and 90 wt. % huntite, between 1 wt. % and 40 wt. % hydromagnesite and between 1 wt. % and 30 wt. % calcium carbonate. In an alternate embodiment, the stabilizer material comprises between 60 wt. % and 80 wt. % huntite, between 20 wt. % and 40 wt. % hydromagnesite and between 1 wt. % and 10 wt. % calcium carbonate.

In one aspect of the present invention, a fertilizer composition is provided, comprising: an ammonium nitrate material; and an effective amount of a stabilizer material to result in a specific impulse reduction of at least 30% when compared to the specific impulse of a commercially available ammonium nitrate composition; wherein the stabilizer material comprises huntite and wherein the stabilizer material is at least 10 wt. % of the total fertilizer composition.

In one aspect of the present invention, a fertilizer composition is provided, comprising: an ammonium nitrate material; and an effective amount of a stabilizer material to result in a specific impulse reduction of at least 50% when compared to the specific impulse of a commercially available ammonium nitrate composition; wherein the stabilizer material comprises huntite and wherein the stabilizer material is at least 12 wt. % of the total fertilizer composition.

In one aspect of the present invention, a fertilizer composition is provided, comprising: an ammonium nitrate material; and an effective amount of a stabilizer material to result in a specific impulse reduction of at least 70% when compared to the specific impulse of a commercially available ammonium nitrate composition; wherein the stabilizer material comprises huntite and wherein the stabilizer material is at least 12.5 wt. % of the total fertilizer composition.

In one aspect of the present invention, a fertilizer composition is provided, comprising: an ammonium nitrate material; and an effective amount of a stabilizer material to result in a specific impulse reduction of at least 90% when compared to the specific impulse of a commercially available ammonium nitrate composition; wherein the stabilizer material comprises huntite and wherein the stabilizer material is at least 17 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 30% when compared to the specific impulse of a commercially available ammonium nitrate composition; wherein the stabilizer material comprises huntite and wherein the stabilizer material is at least 10 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 50% when compared to the specific impulse of a commercially available ammonium nitrate composition; wherein the stabilizer material comprises huntite and wherein the stabilizer material is at least 12 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 70% when compared to the specific impulse of a commercially available ammonium nitrate composition; wherein the stabilizer material comprises huntite and wherein the stabilizer material is at least 12.5 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 90% when compared to the specific impulse of a commercially available ammonium nitrate composition; wherein the stabilizer material comprises huntite and wherein the stabilizer material is at least 17 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 30% less than the specific impulse of a commercially available ammonium nitrate composition; wherein the stabilizer material comprises huntite and wherein the stabilizer material is at least 10 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 50% less than the specific impulse of a commercially available ammonium nitrate composition; wherein the stabilizer material comprises huntite and wherein the stabilizer material is at least 12 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 70% less than the specific impulse of a commercially available ammonium nitrate composition; wherein the stabilizer material comprises huntite and wherein the stabilizer material is at least 12.5 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 90% less than the specific impulse of a commercially available ammonium nitrate composition; wherein the stabilizer material comprises huntite and wherein the stabilizer material is at least 17 wt. % of the total fertilizer composition.

In one aspect of the present invention, a fertilizer composition is provided, comprising: an ammonium nitrate material; and an effective amount of a stabilizer material to result in a specific impulse reduction of at least 10% when compared to the specific impulse of a commercially available ammonium nitrate composition; wherein the stabilizer material comprises magnesite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, a fertilizer composition is provided, comprising: an ammonium nitrate material; and an effective amount of a stabilizer material to result in a specific impulse reduction of at least 10% when compared to the specific impulse of a commercially available ammonium nitrate composition; wherein the stabilizer material comprises magnesite and wherein the stabilizer material is at least 10 wt. % of the total fertilizer composition.

As used herein, “magnesite” is a magnesium carbonate. The formula of magnesite may be represented as MgCO₃, although it will be appreciated that variations on this formula may still describe magnesites.

In one aspect of the present invention, a fertilizer composition is provided, comprising: an ammonium nitrate material; and an effective amount of a stabilizer material to result in a specific impulse reduction of at least 10% when compared to the specific impulse of a commercially available ammonium nitrate composition; wherein the stabilizer material comprises magnesite and wherein the stabilizer material is at least 12.5 wt. % of the total fertilizer composition.

In one aspect of the present invention, a fertilizer composition is provided, comprising: an ammonium nitrate material; and an effective amount of a stabilizer material to result in a specific impulse reduction of at least 10% when compared to the specific impulse of a commercially available ammonium nitrate composition; wherein the stabilizer material comprises magnesite and wherein the stabilizer material is about 10 wt. % to about 25 wt. % of the total fertilizer composition.

In one aspect of the present invention, a fertilizer composition is provided, comprising: an ammonium nitrate material; and an effective amount of a stabilizer material to result in a specific impulse reduction of at least 10% when compared to the specific impulse of a commercially available ammonium nitrate composition; wherein the stabilizer material comprises magnesite and wherein the stabilizer material is about 10 wt. % to about 20 wt. % of the total fertilizer composition.

In one aspect of the present invention, a fertilizer composition is provided, comprising: an ammonium nitrate material; and an effective amount of a stabilizer material to result in a specific impulse reduction of at least 50% when compared to the specific impulse of a commercially available ammonium nitrate composition; wherein the stabilizer material comprises magnesite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, a fertilizer composition is provided, comprising: an ammonium nitrate material; and an effective amount of a stabilizer material to result in a specific impulse reduction of at least 50% when compared to the specific impulse of a commercially available ammonium nitrate composition; wherein the stabilizer material comprises magnesite and wherein the stabilizer material is at least 10 wt. % of the total fertilizer composition.

In one aspect of the present invention, a fertilizer composition is provided, comprising: an ammonium nitrate material; and an effective amount of a stabilizer material to result in a specific impulse reduction of at least 50% when compared to the specific impulse of a commercially available ammonium nitrate composition; wherein the stabilizer material comprises magnesite and wherein the stabilizer material is at least 12.5 wt. % of the total fertilizer composition.

In one aspect of the present invention, a fertilizer composition is provided, comprising: an ammonium nitrate material; and an effective amount of a stabilizer material to result in a specific impulse reduction of at least 50% when compared to the specific impulse of a commercially available ammonium nitrate composition; wherein the stabilizer material comprises magnesite and wherein the stabilizer material is about 10 wt. % to about 25 wt. % of the total fertilizer composition.

In one aspect of the present invention, a fertilizer composition is provided, comprising: an ammonium nitrate material; and an effective amount of a stabilizer material to result in a specific impulse reduction of at least 50% when compared to the specific impulse of a commercially available ammonium nitrate composition; wherein the stabilizer material comprises magnesite and wherein the stabilizer material is about 10 wt. % to about 20 wt. % of the total fertilizer composition.

In one aspect of the present invention, a fertilizer composition is provided, comprising: an ammonium nitrate material; and an effective amount of a stabilizer material to result in a specific impulse reduction of at least 80% when compared to the specific impulse of a commercially available ammonium nitrate composition; wherein the stabilizer material comprises magnesite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, a fertilizer composition is provided, comprising: an ammonium nitrate material; and an effective amount of a stabilizer material to result in a specific impulse reduction of at least 80% when compared to the specific impulse of a commercially available ammonium nitrate composition; wherein the stabilizer material comprises magnesite and wherein the stabilizer material is at least 10 wt. % of the total fertilizer composition.

In one aspect of the present invention, a fertilizer composition is provided, comprising: an ammonium nitrate material; and an effective amount of a stabilizer material to result in a specific impulse reduction of at least 80% when compared to the specific impulse of a commercially available ammonium nitrate composition; wherein the stabilizer material comprises magnesite and wherein the stabilizer material is at least 12.5 wt. % of the total fertilizer composition.

In one aspect of the present invention, a fertilizer composition is provided, comprising: an ammonium nitrate material; and an effective amount of a stabilizer material to result in a specific impulse reduction of at least 80% when compared to the specific impulse of a commercially available ammonium nitrate composition; wherein the stabilizer material comprises magnesite and wherein the stabilizer material is about 10 wt. % to about 25 wt. % of the total fertilizer composition.

In one aspect of the present invention, a fertilizer composition is provided, comprising: an ammonium nitrate material; and an effective amount of a stabilizer material to result in a specific impulse reduction of at least 80% when compared to the specific impulse of a commercially available ammonium nitrate composition; wherein the stabilizer material comprises magnesite and wherein the stabilizer material is about 10 wt. % to about 20 wt. % of the total fertilizer composition.

In one aspect of the present invention, a fertilizer composition is provided, comprising: an ammonium nitrate material; and an effective amount of a stabilizer material to result in a specific impulse reduction of at least 90% when compared to the specific impulse of a commercially available ammonium nitrate composition; wherein the stabilizer material comprises magnesite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, a fertilizer composition is provided, comprising: an ammonium nitrate material; and an effective amount of a stabilizer material to result in a specific impulse reduction of at least 90% when compared to the specific impulse of a commercially available ammonium nitrate composition; wherein the stabilizer material comprises magnesite and wherein the stabilizer material is at least 10 wt. % of the total fertilizer composition.

In one aspect of the present invention, a fertilizer composition is provided, comprising: an ammonium nitrate material; and an effective amount of a stabilizer material to result in a specific impulse reduction of at least 90% when compared to the specific impulse of a commercially available ammonium nitrate composition; wherein the stabilizer material comprises magnesite and wherein the stabilizer material is at least 12.5 wt. % of the total fertilizer composition.

In one aspect of the present invention, a fertilizer composition is provided, comprising: an ammonium nitrate material; and an effective amount of a stabilizer material to result in a specific impulse reduction of at least 90% when compared to the specific impulse of a commercially available ammonium nitrate composition; wherein the stabilizer material comprises magnesite and wherein the stabilizer material is about 10 wt. % to about 25 wt. % of the total fertilizer composition.

In one aspect of the present invention, a fertilizer composition is provided, comprising: an ammonium nitrate material; and an effective amount of a stabilizer material to result in a specific impulse reduction of at least 90% when compared to the specific impulse of a commercially available ammonium nitrate composition; wherein the stabilizer material comprises magnesite and wherein the stabilizer material is about 10 wt. % to about 20 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 10% when compared to the specific impulse of a commercially available ammonium nitrate composition; wherein the stabilizer material comprises magnesite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 10% when compared to the specific impulse of a commercially available ammonium nitrate composition; wherein the stabilizer material comprises magnesite and wherein the stabilizer material is at least 10 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 10% when compared to the specific impulse of a commercially available ammonium nitrate composition; wherein the stabilizer material comprises magnesite and wherein the stabilizer material is at least 12.5 wt. % of the total fertilizer composition.

In one aspect of the present invention, a fertilizer composition is provided, comprising: an ammonium nitrate material; and an effective amount of a stabilizer material to result in a specific impulse reduction of at least 10% when compared to the specific impulse of a commercially available ammonium nitrate composition; wherein the stabilizer material comprises magnesite and wherein the stabilizer material is about 10 wt. % to about 25 wt. % of the total fertilizer composition.

In one aspect of the present invention, a fertilizer composition is provided, comprising: an ammonium nitrate material; and an effective amount of a stabilizer material to result in a specific impulse reduction of at least 10% when compared to the specific impulse of a commercially available ammonium nitrate composition; wherein the stabilizer material comprises magnesite and wherein the stabilizer material is about 10 wt. % to about 20 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 50% when compared to the specific impulse of a commercially available ammonium nitrate composition; wherein the stabilizer material comprises magnesite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 50% when compared to the specific impulse of a commercially available ammonium nitrate composition; wherein the stabilizer material comprises magnesite and wherein the stabilizer material is at least 10 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 50% when compared to the specific impulse of a commercially available ammonium nitrate composition; wherein the stabilizer material comprises magnesite and wherein the stabilizer material is at least 12.5 wt. % of the total fertilizer composition.

In one aspect of the present invention, a fertilizer composition is provided, comprising: an ammonium nitrate material; and an effective amount of a stabilizer material to result in a specific impulse reduction of at least 50% when compared to the specific impulse of a commercially available ammonium nitrate composition; wherein the stabilizer material comprises magnesite and wherein the stabilizer material is about 10 wt. % to about 25 wt. % of the total fertilizer composition.

In one aspect of the present invention, a fertilizer composition is provided, comprising: an ammonium nitrate material; and an effective amount of a stabilizer material to result in a specific impulse reduction of at least 50% when compared to the specific impulse of a commercially available ammonium nitrate composition; wherein the stabilizer material comprises magnesite and wherein the stabilizer material is about 10 wt. % to about 20 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 80% when compared to the specific impulse of a commercially available ammonium nitrate composition; wherein the stabilizer material comprises magnesite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 80% when compared to the specific impulse of a commercially available ammonium nitrate composition; wherein the stabilizer material comprises magnesite and wherein the stabilizer material is at least 10 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 80% when compared to the specific impulse of a commercially available ammonium nitrate composition; wherein the stabilizer material comprises magnesite and wherein the stabilizer material is at least 12.5 wt. % of the total fertilizer composition.

In one aspect of the present invention, a fertilizer composition is provided, comprising: an ammonium nitrate material; and an effective amount of a stabilizer material to result in a specific impulse reduction of at least 80% when compared to the specific impulse of a commercially available ammonium nitrate composition; wherein the stabilizer material comprises magnesite and wherein the stabilizer material is about 10 wt. % to about 25 wt. % of the total fertilizer composition.

In one aspect of the present invention, a fertilizer composition is provided, comprising: an ammonium nitrate material; and an effective amount of a stabilizer material to result in a specific impulse reduction of at least 80% when compared to the specific impulse of a commercially available ammonium nitrate composition; wherein the stabilizer material comprises magnesite and wherein the stabilizer material is about 10 wt. % to about 20 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 90% when compared to the specific impulse of a commercially available ammonium nitrate composition; wherein the stabilizer material comprises magnesite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 90% when compared to the specific impulse of a commercially available ammonium nitrate composition; wherein the stabilizer material comprises magnesite and wherein the stabilizer material is at least 10 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 90% when compared to the specific impulse of a commercially available ammonium nitrate composition; wherein the stabilizer material comprises magnesite and wherein the stabilizer material is at least 12.5 wt. % of the total fertilizer composition.

In one aspect of the present invention, a fertilizer composition is provided, comprising: an ammonium nitrate material; and an effective amount of a stabilizer material to result in a specific impulse reduction of at least 90% when compared to the specific impulse of a commercially available ammonium nitrate composition; wherein the stabilizer material comprises magnesite and wherein the stabilizer material is about 10 wt. % to about 25 wt. % of the total fertilizer composition.

In one aspect of the present invention, a fertilizer composition is provided, comprising: an ammonium nitrate material; and an effective amount of a stabilizer material to result in a specific impulse reduction of at least 90% when compared to the specific impulse of a commercially available ammonium nitrate composition; wherein the stabilizer material comprises magnesite and wherein the stabilizer material is about 10 wt. % to about 20 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 10% less than the specific impulse of a commercially available ammonium nitrate composition; wherein the stabilizer material comprises magnesite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 10% less than the specific impulse of a commercially available ammonium nitrate composition; wherein the stabilizer material comprises magnesite and wherein the stabilizer material is at least 10 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 10% less than the specific impulse of a commercially available ammonium nitrate composition; wherein the stabilizer material comprises magnesite and wherein the stabilizer material is at least 12.5 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 10% less than the specific impulse of a commercially available ammonium nitrate composition; wherein the stabilizer material comprises magnesite and wherein the stabilizer material is about 10 wt. % to about 25 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 10% less than the specific impulse of a commercially available ammonium nitrate composition; wherein the stabilizer material comprises magnesite and wherein the stabilizer material is about 10 wt. % to about 20 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 50% less than the specific impulse of a commercially available ammonium nitrate composition; wherein the stabilizer material comprises magnesite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 50% less than the specific impulse of a commercially available ammonium nitrate composition; wherein the stabilizer material comprises magnesite and wherein the stabilizer material is at least 10 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 50% less than the specific impulse of a commercially available ammonium nitrate composition; wherein the stabilizer material comprises magnesite and wherein the stabilizer material is at least 12.5 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 50% less than the specific impulse of a commercially available ammonium nitrate composition; wherein the stabilizer material comprises magnesite and wherein the stabilizer material is about 10 wt. % to about 25 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 50% less than the specific impulse of a commercially available ammonium nitrate composition; wherein the stabilizer material comprises magnesite and wherein the stabilizer material is about 10 wt. % to about 20 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 80% less than the specific impulse of a commercially available ammonium nitrate composition; wherein the stabilizer material comprises magnesite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 80% less than the specific impulse of a commercially available ammonium nitrate composition; wherein the stabilizer material comprises magnesite and wherein the stabilizer material is at least 10 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 80% less than the specific impulse of a commercially available ammonium nitrate composition; wherein the stabilizer material comprises magnesite and wherein the stabilizer material is at least 12.5 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 80% less than the specific impulse of a commercially available ammonium nitrate composition; wherein the stabilizer material comprises magnesite and wherein the stabilizer material is about 10 wt. % to about 25 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 80% less than the specific impulse of a commercially available ammonium nitrate composition; wherein the stabilizer material comprises magnesite and wherein the stabilizer material is about 10 wt. % to about 20 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 90% less than the specific impulse of a commercially available ammonium nitrate composition; wherein the stabilizer material comprises magnesite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 90% less than the specific impulse of a commercially available ammonium nitrate composition; wherein the stabilizer material comprises magnesite and wherein the stabilizer material is at least 10 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 90% less than the specific impulse of a commercially available ammonium nitrate composition; wherein the stabilizer material comprises magnesite and wherein the stabilizer material is at least 12.5 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 90% less than the specific impulse of a commercially available ammonium nitrate composition; wherein the stabilizer material comprises magnesite and wherein the stabilizer material is about 10 wt. % to about 25 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 90% less than the specific impulse of a commercially available ammonium nitrate composition; wherein the stabilizer material comprises magnesite and wherein the stabilizer material is about 10 wt. % to about 20 wt. % of the total fertilizer composition.

In one aspect of the present invention, there is provided a method for the use of a stabilizer material for the preparation of an ammonium nitrate fertilizer composition, wherein the fertilizer composition comprises at an effective amount of a stabilizer material to result in a specific impulse reduction of at least 10% when compared to the specific impulse of a commercially available ammonium nitrate composition; wherein the stabilizer material comprises magnesite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, there is provided a method for the use of a stabilizer material for the preparation of an ammonium nitrate fertilizer composition, wherein the fertilizer composition comprises at an effective amount of a stabilizer material to result in a specific impulse reduction of at least 10% when compared to the specific impulse of a commercially available ammonium nitrate composition; wherein the stabilizer material comprises magnesite and wherein the stabilizer material is at least 10 wt. % of the total fertilizer composition.

In one aspect of the present invention, there is provided a method for the use of a stabilizer material for the preparation of an ammonium nitrate fertilizer composition, wherein the fertilizer composition comprises at an effective amount of a stabilizer material to result in a specific impulse reduction of at least 10% when compared to the specific impulse of a commercially available ammonium nitrate composition; wherein the stabilizer material comprises magnesite and wherein the stabilizer material is at least 12.5 wt. % of the total fertilizer composition.

In one aspect of the present invention, there is provided a method for the use of a stabilizer material for the preparation of an ammonium nitrate fertilizer composition, wherein the fertilizer composition comprises at an effective amount of a stabilizer material to result in a specific impulse reduction of at least 10% when compared to the specific impulse of a commercially available ammonium nitrate composition; wherein the stabilizer material comprises magnesite and wherein the stabilizer material is about 10 wt. % to about 25 wt. % of the total fertilizer composition.

In one aspect of the present invention, there is provided a method for the use of a stabilizer material for the preparation of an ammonium nitrate fertilizer composition, wherein the fertilizer composition comprises at an effective amount of a stabilizer material to result in a specific impulse reduction of at least 10% when compared to the specific impulse of a commercially available ammonium nitrate composition; wherein the stabilizer material comprises magnesite and wherein the stabilizer material is about 10 wt. % to about 20 wt. % of the total fertilizer composition.

In one aspect of the present invention, there is provided a method for the use of a stabilizer material for the preparation of an ammonium nitrate fertilizer composition, wherein the fertilizer composition comprises at an effective amount of a stabilizer material to result in a specific impulse reduction of at least 50% when compared to the specific impulse of a commercially available ammonium nitrate composition; wherein the stabilizer material comprises magnesite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, there is provided a method for the use of a stabilizer material for the preparation of an ammonium nitrate fertilizer composition, wherein the fertilizer composition comprises at an effective amount of a stabilizer material to result in a specific impulse reduction of at least 50% when compared to the specific impulse of a commercially available ammonium nitrate composition; wherein the stabilizer material comprises magnesite and wherein the stabilizer material is at least 10 wt. % of the total fertilizer composition.

In one aspect of the present invention, there is provided a method for the use of a stabilizer material for the preparation of an ammonium nitrate fertilizer composition, wherein the fertilizer composition comprises at an effective amount of a stabilizer material to result in a specific impulse reduction of at least 50% when compared to the specific impulse of a commercially available ammonium nitrate composition; wherein the stabilizer material comprises magnesite and wherein the stabilizer material is at least 12.5 wt. % of the total fertilizer composition.

In one aspect of the present invention, there is provided a method for the use of a stabilizer material for the preparation of an ammonium nitrate fertilizer composition, wherein the fertilizer composition comprises at an effective amount of a stabilizer material to result in a specific impulse reduction of at least 50% when compared to the specific impulse of a commercially available ammonium nitrate composition; wherein the stabilizer material comprises magnesite and wherein the stabilizer material is about 10 wt. % to about 25 wt. % of the total fertilizer composition.

In one aspect of the present invention, there is provided a method for the use of a stabilizer material for the preparation of an ammonium nitrate fertilizer composition, wherein the fertilizer composition comprises at an effective amount of a stabilizer material to result in a specific impulse reduction of at least 50% when compared to the specific impulse of a commercially available ammonium nitrate composition; wherein the stabilizer material comprises magnesite and wherein the stabilizer material is about 10 wt. % to about 20 wt. % of the total fertilizer composition.

In one aspect of the present invention, there is provided a method for the use of a stabilizer material for the preparation of an ammonium nitrate fertilizer composition, wherein the fertilizer composition comprises at an effective amount of a stabilizer material to result in a specific impulse reduction of at least 80% when compared to the specific impulse of a commercially available ammonium nitrate composition; wherein the stabilizer material comprises magnesite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, there is provided a method for the use of a stabilizer material for the preparation of an ammonium nitrate fertilizer composition, wherein the fertilizer composition comprises at an effective amount of a stabilizer material to result in a specific impulse reduction of at least 80% when compared to the specific impulse of a commercially available ammonium nitrate composition; wherein the stabilizer material comprises magnesite and wherein the stabilizer material is at least 10 wt. % of the total fertilizer composition.

In one aspect of the present invention, there is provided a method for the use of a stabilizer material for the preparation of an ammonium nitrate fertilizer composition, wherein the fertilizer composition comprises at an effective amount of a stabilizer material to result in a specific impulse reduction of at least 80% when compared to the specific impulse of a commercially available ammonium nitrate composition; wherein the stabilizer material comprises magnesite and wherein the stabilizer material is at least 12.5 wt. % of the total fertilizer composition.

In one aspect of the present invention, there is provided a method for the use of a stabilizer material for the preparation of an ammonium nitrate fertilizer composition, wherein the fertilizer composition comprises at an effective amount of a stabilizer material to result in a specific impulse reduction of at least 80% when compared to the specific impulse of a commercially available ammonium nitrate composition; wherein the stabilizer material comprises magnesite and wherein the stabilizer material is about 10 wt. % to about 25 wt. % of the total fertilizer composition.

In one aspect of the present invention, there is provided a method for the use of a stabilizer material for the preparation of an ammonium nitrate fertilizer composition, wherein the fertilizer composition comprises at an effective amount of a stabilizer material to result in a specific impulse reduction of at least 80% when compared to the specific impulse of a commercially available ammonium nitrate composition; wherein the stabilizer material comprises magnesite and wherein the stabilizer material is about 10 wt. % to about 20 wt. % of the total fertilizer composition.

In one aspect of the present invention, there is provided a method for the use of a stabilizer material for the preparation of an ammonium nitrate fertilizer composition, wherein the fertilizer composition comprises at an effective amount of a stabilizer material to result in a specific impulse reduction of at least 90% when compared to the specific impulse of a commercially available ammonium nitrate composition; wherein the stabilizer material comprises magnesite and wherein the stabilizer material is at least 1 wt. % or at least 2 wt. % or at least 3 wt. % or at least 4 wt. % or at least 5 wt. % or at least 6 wt. % or at least 7 wt. % or at least 8 wt. % or at least 9 wt. % of the total fertilizer composition.

In one aspect of the present invention, there is provided a method for the use of a stabilizer material for the preparation of an ammonium nitrate fertilizer composition, wherein the fertilizer composition comprises at an effective amount of a stabilizer material to result in a specific impulse reduction of at least 90% when compared to the specific impulse of a commercially available ammonium nitrate composition; wherein the stabilizer material comprises magnesite and wherein the stabilizer material is at least 10 wt. % of the total fertilizer composition.

In one aspect of the present invention, there is provided a method for the use of a stabilizer material for the preparation of an ammonium nitrate fertilizer composition, wherein the fertilizer composition comprises at an effective amount of a stabilizer material to result in a specific impulse reduction of at least 90% when compared to the specific impulse of a commercially available ammonium nitrate composition; wherein the stabilizer material comprises magnesite and wherein the stabilizer material is at least 12.5 wt. % of the total fertilizer composition.

In one aspect of the present invention, there is provided a method for the use of a stabilizer material for the preparation of an ammonium nitrate fertilizer composition, wherein the fertilizer composition comprises at an effective amount of a stabilizer material to result in a specific impulse reduction of at least 90% when compared to the specific impulse of a commercially available ammonium nitrate composition; wherein the stabilizer material comprises magnesite and wherein the stabilizer material is about 10 wt. % to about 25 wt. % of the total fertilizer composition.

In one aspect of the present invention, there is provided a method for the use of a stabilizer material for the preparation of an ammonium nitrate fertilizer composition, wherein the fertilizer composition comprises at an effective amount of a stabilizer material to result in a specific impulse reduction of at least 90% when compared to the specific impulse of a commercially available ammonium nitrate composition; wherein the stabilizer material comprises magnesite and wherein the stabilizer material is about 10 wt. % to about 20 wt. % of the total fertilizer composition.

In one aspect of the present invention, a fertilizer composition is provided, comprising: an ammonium nitrate material; and an effective amount of a stabilizer material to result in a specific impulse reduction of at least 30% when compared to the specific impulse of a commercially available ammonium nitrate composition; wherein the stabilizer material comprises magnesite and wherein the stabilizer material is at least 14 wt. % of the total fertilizer composition.

In one aspect of the present invention, a fertilizer composition is provided, comprising: an ammonium nitrate material; and an effective amount of a stabilizer material to result in a specific impulse reduction of at least 50% when compared to the specific impulse of a commercially available ammonium nitrate composition; wherein the stabilizer material comprises magnesite and wherein the stabilizer material is at least 15 wt. % of the total fertilizer composition.

In one aspect of the present invention, a fertilizer composition is provided, comprising: an ammonium nitrate material; and an effective amount of a stabilizer material to result in a specific impulse reduction of at least 70% when compared to the specific impulse of a commercially available ammonium nitrate composition; wherein the stabilizer material comprises magnesite and wherein the stabilizer material is at least 17 wt. % of the total fertilizer composition.

In one aspect of the present invention, a fertilizer composition is provided, comprising: an ammonium nitrate material; and an effective amount of a stabilizer material to result in a specific impulse reduction of at least 90% when compared to the specific impulse of a commercially available ammonium nitrate composition; wherein the stabilizer material comprises magnesite and wherein the stabilizer material is at least 20 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 30% when compared to the specific impulse of a commercially available ammonium nitrate composition; wherein the stabilizer material comprises magnesite and wherein the stabilizer material is at least 14 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 50% when compared to the specific impulse of a commercially available ammonium nitrate composition; wherein the stabilizer material comprises magnesite and wherein the stabilizer material is at least 15 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 70% when compared to the specific impulse of a commercially available ammonium nitrate composition; wherein the stabilizer material comprises magnesite and wherein the stabilizer material is at least 17 wt. % of the total fertilizer composition.

In one aspect of the present invention, there is provided a method of preparing a fertilizer composition comprising the step of combining an ammonium nitrate material and an effective amount of a stabilizer material to result in a fertilizer composition with specific impulse reduction of at least 90% when compared to the specific impulse of a commercially available ammonium nitrate composition; wherein the stabilizer material comprises magnesite and wherein the stabilizer material is at least 20 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 30% less than the specific impulse of a commercially available ammonium nitrate composition; wherein the stabilizer material comprises magnesite and wherein the stabilizer material is at least 14 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 50% less than the specific impulse of a commercially available ammonium nitrate composition; wherein the stabilizer material comprises magnesite and wherein the stabilizer material is at least 15 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 70% less than the specific impulse of a commercially available ammonium nitrate composition; wherein the stabilizer material comprises magnesite and wherein the stabilizer material is at least 17 wt. % of the total fertilizer composition.

In one aspect of the present invention, there is provided a method for decreasing the specific impulse of an ammonium nitrate material, wherein the method comprises the step of combining the ammonium nitrate material with an effective amount of a stabilizer material to result in a fertilizer composition with specific impulse of at least 90% less than the specific impulse of a commercially available ammonium nitrate composition; wherein the stabilizer material comprises magnesite and wherein the stabilizer material is at least 20 wt. % of the total fertilizer composition.

In some embodiments, a fertilizer composition in accordance with the instant disclosure comprises a specific impulse reduction of at least 10%, at least 12.5%; at least 15%; at least 20%; at least 25%; at least 30%; at least 35%; at least 40%; at least 45%; at least 50%; at least 55%; at least 60%; at least 65%; at least 70%; at least 75%; at least 80%; at least 85%; at least 90%; or at least 95%; or at least 96%; or at least 97%; or at least 98%; or at least 99%, when compared to the specific impulse of a commercially available ammonium nitrate fertilizer composition.

In some embodiments, a fertilizer composition in accordance with the instant disclosure comprises: not greater than a 10% reduction in specific impulse; not greater than a 15% reduction in specific impulse; not greater than a 20% reduction in specific impulse; not greater than a 25% reduction in specific impulse; not greater than a 30% reduction in specific impulse; not greater than a 35% reduction in specific impulse; not greater than a 40% reduction in specific impulse; not greater than a 45% reduction in specific impulse; not greater than a 50% reduction in specific impulse; not greater than a 55% reduction in specific impulse; not greater than a 60% reduction in specific impulse; not greater than a 65% reduction in specific impulse; not greater than a 70% reduction in specific impulse; not greater than a 75% reduction in specific impulse; not greater than a 80% reduction in specific impulse; not greater than a 85% reduction in specific impulse; not greater than a 90% reduction in specific impulse; not greater than a 95% reduction in specific impulse not greater than a 96% reduction in specific impulse; not greater than a 97% reduction in specific impulse; not greater than a 98% reduction in specific impulse; not greater than a 99% reduction in specific impulse; when compared to the specific impulse of a commercially available ammonium nitrate fertilizer composition.

In some embodiments, the fertilizer composition comprises: between 10-25 wt. % stabilizer material; between 10-24 wt. % stabilizer material; between 10-23 wt. % stabilizer material; between 10-22 wt. % stabilizer material; between 10-21 wt. % stabilizer material; between 10-20 wt. % stabilizer material; between 10-19 wt. % stabilizer material; between 10-18 wt. % stabilizer material; between 10-17 wt. % stabilizer material; between 10-16 wt. % stabilizer material; between 10-15 wt. % stabilizer material; between 10-14 wt. % stabilizer material; between 10-13 wt. % stabilizer material; between 10-12 wt. % stabilizer material; between 10-11 wt. % stabilizer material.

In some embodiments, the fertilizer composition comprises: between 11-25 wt. % stabilizer material; between 12-25 wt. % stabilizer material; between 13-25 wt. % stabilizer material; between 14-25 wt. % stabilizer material; between 15-25 wt. % stabilizer material; between 16-25 wt. % stabilizer material; between 17-25 wt. % stabilizer material; between 18-25 wt. % stabilizer material; between 19-25 wt. % stabilizer material; between 20-25 wt. % stabilizer material; between 21-25 wt. % stabilizer material; between 22-25 wt. % stabilizer material; between 23-25 wt. % stabilizer material; between 24-25 wt. % stabilizer material.

In some embodiments, the fertilizer composition comprises: between 10-12 wt. % stabilizer material; between 11-13 wt. % stabilizer material; between 12-14 wt. % stabilizer material; between 13-15 wt. % stabilizer material; between 14-16 wt. % stabilizer material; between 15-17 wt. % stabilizer material; between 16-18 wt. % stabilizer material; between 17-19 wt. % stabilizer material; between 18-20 wt. % stabilizer material; between 19-21 wt. % stabilizer material; between 20-22 wt. % stabilizer material; between 21-23 wt. % stabilizer material; between 22-24 wt. % stabilizer material.

In some embodiments, the fertilizer composition comprises: between 10-13 wt. % stabilizer material; between 11-14 wt. % stabilizer material; between 12-15 wt. % stabilizer material; between 13-16 wt. % stabilizer material; between 14-17 wt. % stabilizer material; between 15-18 wt. % stabilizer material; between 16-19 wt. % stabilizer material; between 17-20 wt. % stabilizer material; between 18-21 wt. % stabilizer material; between 19-22 wt. % stabilizer material; between 20-23 wt. % stabilizer material; between 21-24 wt. % stabilizer material.

In some embodiments, the fertilizer composition comprises: between 10-14 wt. % stabilizer material; between 11-15 wt. % stabilizer material; between 12-16 wt. % stabilizer material; between 13-17 wt. % stabilizer material; between 14-18 wt. % stabilizer material; between 15-19 wt. % stabilizer material; between 16-20 wt. % stabilizer material; between 17-21 wt. % stabilizer material; between 18-22 wt. % stabilizer material; between 19-23 wt. % stabilizer material; between 20-24 wt. % stabilizer material.

In some embodiments, the fertilizer composition comprises: between 10-15 wt. % stabilizer material; between 11-16 wt. % stabilizer material; between 12-17 wt. % stabilizer material; between 13-18 wt. % stabilizer material; between 14-19 wt. % stabilizer material; between 15-20 wt. % stabilizer material; between 16-21 wt. % stabilizer material; between 17-22 wt. % stabilizer material; between 18-23 wt. % stabilizer material; between 19-24 wt. % stabilizer material.

In some embodiments, the fertilizer composition comprises: between 10-16 wt. % stabilizer material; between 11-17 wt. % stabilizer material; between 12-18 wt. % stabilizer material; between 13-19 wt. % stabilizer material; between 14-20 wt. % stabilizer material; between 15-21 wt. % stabilizer material; between 16-22 wt. % stabilizer material; between 17-23 wt. % stabilizer material; between 18-24 wt. % stabilizer material.

In some embodiments, the fertilizer composition comprises: between 10-17 wt. % stabilizer material; between 11-18 wt. % stabilizer material; between 12-19 wt. % stabilizer material; between 13-20 wt. % stabilizer material; between 14-21 wt. % stabilizer material; between 15-22 wt. % stabilizer material; between 16-23 wt. % stabilizer material; between 17-24 wt. % stabilizer material.

In some embodiments, the fertilizer composition comprises: between 10-18 wt. % stabilizer material; between 11-19 wt. % stabilizer material; between 12-20 wt. % stabilizer material; between 13-21 wt. % stabilizer material; between 14-22 wt. % stabilizer material; between 15-23 wt. % stabilizer material; between 16-24 wt. % stabilizer material.

In some embodiments, the fertilizer composition comprises: between 10-19 wt. % stabilizer material; between 11-20 wt. % stabilizer material; between 12-21 wt. % stabilizer material; between 13-22 wt. % stabilizer material; between 14-23 wt. % stabilizer material; between 15-24 wt. % stabilizer material.

In some embodiments, the fertilizer composition comprises: between 10-20 wt. % stabilizer material; between 11-21 wt. % stabilizer material; between 12-22 wt. % stabilizer material; between 13-23 wt. % stabilizer material; between 14-24 wt. % stabilizer material.

In some embodiments, the fertilizer composition comprises: between 10-21 wt. % stabilizer material; between 11-22 wt. % stabilizer material; between 12-23 wt. % stabilizer material; between 13-24 wt. % stabilizer material.

In some embodiments, the fertilizer composition comprises: between 10-22 wt. % stabilizer material; between 11-23 wt. % stabilizer material; between 12-24 wt. % stabilizer material.

In some embodiments, the fertilizer composition comprises: between 10-23 wt. % stabilizer material; between 11-24 wt. % stabilizer material.

In some embodiments, the fertilizer composition comprises: between 10-24 wt. % stabilizer material.

In one form of the present invention, the fertilizer composition comprises at least 50 wt. % ammonium nitrate. In an alternate form of the present invention, the fertilizer composition comprises at least 55 wt. % ammonium nitrate. In an alternate form of the present invention, the fertilizer composition comprises at least 60 wt. % ammonium nitrate. In an alternate form of the present invention, the fertilizer composition comprises at least 65 wt. % ammonium nitrate. In an alternate form of the present invention, the fertilizer composition comprises at least 70 wt. % ammonium nitrate. In an alternate form of the present invention, the fertilizer composition comprises at least 75 wt. % ammonium nitrate. In an alternate form of the present invention, the fertilizer composition comprises at least 80 wt. % ammonium nitrate. In an alternate form of the present invention, the fertilizer composition comprises at least 85 wt. % ammonium nitrate. In an alternate form of the present invention, the fertilizer composition comprises at least 90 wt. % ammonium nitrate. In an alternate form of the present invention, the fertilizer composition comprises at least 91 wt. % ammonium nitrate. In an alternate form of the present invention, the fertilizer composition comprises at least 92 wt. % ammonium nitrate. In an alternate form of the present invention, the fertilizer composition comprises at least 93 wt. % ammonium nitrate. In an alternate form of the present invention, the fertilizer composition comprises at least 94 wt. % ammonium nitrate. In an alternate form of the present invention, the fertilizer composition comprises at least 95 wt. % ammonium nitrate. In an alternate form of the present invention, the fertilizer composition comprises at least 96 wt. % ammonium nitrate. In an alternate form of the present invention, the fertilizer composition comprises at least 97 wt. % ammonium nitrate. In an alternate form of the present invention, the fertilizer composition comprises at least 98 wt. % ammonium nitrate. In an alternate form of the present invention, the fertilizer composition comprises at least 99 wt. % ammonium nitrate.

In one form of the present invention, the ammonium nitrate and the stabilizer material comprise 100 wt. % of the fertilizer composition. In an alternate form of the present invention, the ammonium nitrate and the stabilizer material comprise at least 99 wt. % of the fertilizer composition. In an alternate form of the present invention, the ammonium nitrate and the stabilizer material comprise at least 98 wt. % of the fertilizer composition. In an alternate form of the present invention, the ammonium nitrate and the stabilizer material comprise at least 97 wt. % of the fertilizer composition. In an alternate form of the present invention, the ammonium nitrate and the stabilizer material comprise at least 96 wt. % of the fertilizer composition. In an alternate form of the present invention, the ammonium nitrate and the stabilizer material comprise at least 95 wt. % of the fertilizer composition. In an alternate form of the present invention, the ammonium nitrate and the stabilizer material comprise at least 90 wt. % of the fertilizer composition. In an alternate form of the present invention, the ammonium nitrate and the stabilizer material comprise at least 85 wt. % of the fertilizer composition. In an alternate form of the present invention, the ammonium nitrate and the stabilizer material comprise at least 80 wt. % of the fertilizer composition. In an alternate form of the present invention, the ammonium nitrate and the stabilizer material comprise at least 75 wt. % of the fertilizer composition. In an alternate form of the present invention, the ammonium nitrate and the stabilizer material comprise at least 70 wt. % of the fertilizer composition. In an alternate form of the present invention, the ammonium nitrate and the stabilizer material comprise at least 65 wt. % of the fertilizer composition. In an alternate form of the present invention, the ammonium nitrate and the stabilizer material comprise at least 60 wt. % of the fertilizer composition. In an alternate form of the present invention, the ammonium nitrate and the stabilizer material comprise at least 55 wt. % of the fertilizer composition. In an alternate form of the present invention, the ammonium nitrate and the stabilizer material comprise at least 50 wt. % of the fertilizer composition.

In one form of the present invention, the ammonium nitrate and the stabilizer material comprises no more than 99 wt. % of the fertilizer composition. In an alternate form of the present invention, the ammonium nitrate and the stabilizer material comprises no more than 98 wt. % of the fertilizer composition. In an alternate form of the present invention, the ammonium nitrate and the stabilizer material comprises no more than 97 wt. % of the fertilizer composition. In an alternate form of the present invention, the ammonium nitrate and the stabilizer material comprises no more than 96 wt. % of the fertilizer composition. In an alternate form of the present invention, the ammonium nitrate and the stabilizer material comprises no more than 95 wt. % of the fertilizer composition. In an alternate form of the present invention, the ammonium nitrate and the stabilizer material comprises no more than 90 wt. % of the fertilizer composition. In an alternate form of the present invention, the ammonium nitrate and the stabilizer material comprises no more than 85 wt. % of the fertilizer composition. In an alternate form of the present invention, the ammonium nitrate and the stabilizer material comprises no more than 80 wt. % of the fertilizer composition. In an alternate form of the present invention, the ammonium nitrate and the stabilizer material comprises no more than 75 wt. % of the fertilizer composition. In an alternate form of the present invention, the ammonium nitrate and the stabilizer material comprises no more than 70 wt. % of the fertilizer composition. In an alternate form of the present invention, the ammonium nitrate and the stabilizer material comprises no more than 65 wt. % of the fertilizer composition. In an alternate form of the present invention, the ammonium nitrate and the stabilizer material comprises no more than 60 wt. % of the fertilizer composition. In an alternate form of the present invention, the ammonium nitrate and the stabilizer material comprises no more than 55 wt. % of the fertilizer composition. In an alternate form of the present invention, the ammonium nitrate and the stabilizer material comprises no more than 50 wt. % of the fertilizer composition.

In one embodiment, the stabilizer material further comprises an aluminium production byproduct.

In one form of the invention, at least a portion of the stabilizer material is synthetic. In the context of the present invention, the term synthetic shall be taken to encompass the preparation of a stabilizer material using materials from any source including but not limited to materials from an aluminium production process. For example, huntite and hydromagnesite may be prepared using Bayer liquor.

In one form of the invention, at least a portion of the stabilizer material is sourced from an aluminium production process.

In one form of the invention, at least a portion of the stabilizer material is naturally occurring.

As used herein, “aluminium production byproduct” means: a compound or class of materials that is produced by one or more processes of making aluminium. Some non-limiting processes include: the Bayer process, smelting, refining, casting, recycling, and producing various products, product forms, and combinations thereof.

Some non-limiting examples of stabilizer materials that are products of aluminium production and/or processing include: apatite, electrostatic precipitator fines (ESP), Bayer process byproducts, and combinations thereof.

As used herein, “Bayer process byproduct” means: a substance produced during the reduction of bauxite to form/produce alumina. Non-limiting examples of stabilizer materials that are Bayer process byproducts include: layered double hydroxides, hydrotalcite, bauxite residue, neutralized bauxite residue, dawsonite, fukalite, aluminium hydroxide, smelter grade alumina (SGA), and combinations thereof.

In one embodiment, the stabilizer material further comprises a layered double hydroxide.

The layered double hydroxide may be naturally occurring or may be sourced from an aluminium production process.

As used herein, “layered double hydroxide” means: a class of compounds which are characterized by multiple (e.g. two) positively charged layers and weakly bound, often exchangeable central ion(s) (e.g. negatively charged ions) located in the interlayer (middle) region. As a non-limiting example, LDHs are commonly referred to by the following generic chemical formula:

[M²⁺₁₋ₓM³⁺(OH)₂]^{q+}(Xn−)_{q/n-}*yH₂O (eq. 1)

As some non-limiting examples, z=2, M²⁺=Ca, Mg, Mn, Fe, Co, Ni, Cu or Zn, (hence q=x).

Non-limiting examples of LDH compounds include: hydrotalcites, hydrocalumite, hydromagnesite, takovite, woolite, and combinations thereof.

In some embodiments, LDH comprises hydrotalcite (HTC). In some embodiments, LDH comprises hydrocalumite.

As used herein, “hydrotalcite” means: a layered double hydroxide of the following formula:

Mg₆Al₂(CO₃)(OH)₁₆*4(H₂O) (eq. 2)

Non-limiting examples of groups of materials within the hydrotalcites supergroup include: hydrotalcites group, quintinite group, fougerite group, woodwardite group, glaucerinite group, cualstibite group, hydrocalumite group, and unclassified.

Non-limiting examples of hydrotalcites include: pyroaurite, stichtite, meixnerite, iowaite, droninoite, woodallite, desaurelsite, takovite, reevesite, jamborite, quintinite, charmarite, caresite, zaccagnaite, chrlomagaluminite, fougerite, woodwardite, zincowoodwardite, honessite, claucocerinite, hydrowoodwardite, carrboydite, hydrohonessite, mountkeithite, sincaluminite, wermlandite, shigaite, nikischerite, motukoreaite, natroglaucocerinite, karchevskyite, cualstibite, xincalstibite, hydroclumite, kuzelite, coalingite, brugnatellite, muskoxite, and combinations thereof.

In one form of the invention, the stabilizer material comprises at least 10% layered double hydroxide. In an alternate form of the invention, the stabilizer material comprises at least 20% layered double hydroxide. In an alternate form of the invention, the stabilizer material comprises at least 30% layered double hydroxide. In an alternate form of the invention, the stabilizer material comprises at least 40% layered double hydroxide. In an alternate form of the invention, the stabilizer material comprises at least 50% layered double hydroxide. In an alternate form of the invention, the stabilizer material comprises at least 60% layered double hydroxide. In an alternate form of the invention, the stabilizer material comprises at least 70% layered double hydroxide. In an alternate form of the invention, the stabilizer material comprises at least 80% layered double hydroxide. In an alternate form of the invention, the stabilizer material comprises at least 90% layered double hydroxide.

In one embodiment, the stabilizer material further comprises an apatite.

As used herein, “apatite” means: a phosphate mineral having calcium phosphate with some fluorine, chlorine, and other elements. In some embodiments, apatite is neutralized with group of phosphate minerals. One example of an apatite compound is hydroxyapatite.

In one form of the invention, the stabilizer material comprises at least 10% apatite. In an alternate form of the invention, the stabilizer material comprises at least 20% apatite. In an alternate form of the invention, the stabilizer material comprises at least 30% apatite. In an alternate form of the invention, the stabilizer material comprises at least 40% apatite. In an alternate form of the invention, the stabilizer material comprises at least 50% apatite. In an alternate form of the invention, the stabilizer material comprises at least 60% apatite. In an alternate form of the invention, the stabilizer material comprises at least 70% apatite. In an alternate form of the invention, the stabilizer material comprises at least 80% apatite. In an alternate form of the invention, the stabilizer material comprises at least 90% apatite.

In some embodiments, fertilizer compositions of the instant disclosure provide for slow release of the fertilizer compounds (as compared to AN fertilizer).

As used herein, “AN-type explosive” means: ammonium nitrate-based fuel explosives, where fuels include fuel oil (ANFO-type explosives) or other fuels like powdered sugar or aluminium powder.

As used herein, “fertilizer” means: a substance used to make soil more fertile. In some embodiments of the instant disclosure, a fertilizer includes ammonium nitrate. In other embodiments, fertilizer is ammonium nitrate fertilizer which includes at least one stabilizer material, where the stabilizer material is present in a specified amount so as the resulting specific impulse of the fertilizer is not greater than a predetermined threshold, or the reduction in specific impulse is above a predetermined threshold when measured in accordance with a blast propagation test.

As used herein, “form” means: the shape or structure of something (as distinguished from its material composition). As some non-limiting examples, the fertilizer form includes: pellets, prills, granules, powder, and combinations thereof.

Generally, addition of a stabilizer material in accordance with the instant disclosure causes blast suppression and/or a desensitization of the resulting fertilizer composition.

As used herein, “blast suppression” means: the reduction of a materials tendency to explode (as measured by specific impulse).

As used herein, “blast suppression test” means a test to measure the quantity and/or quality of blast suppression of an underlying stabilizer material present in a fertilizer composition for a given mesh size (e.g. 20, 40, or 60 mesh). In some embodiments, blast suppression test means a test article set atop a witness plate, where the test article houses a fertilizer composition (which includes the stabilizer material) and a detonator (C4 booster) placed adjacent to the top end of the test article. In some embodiments, overpressure sensors positioned a set distance from the test article are used to quantify the specific impulse of the blast. In some embodiments, the witness plate is used to obtain qualitative data from the blast (perforation means a detonation of fertilizer composition occurred, non-perforation means no detonation of the fertilizer composition occurred). In some embodiments, variables like test article diameter, booster quantity, and fuel oil quantity are used to obtain desensitization measurements (i.e. an increase in diameter of the test article to account for an increase in unconfined critical diameter, an increase in booster quantity required to detonate the fertilizer composition, an increase in fuel oil in the fertilizer composition, and/or combinations thereof)

As used herein, “pressure impulse” refers to the amount of pressure measured during a detonation of an explosive (e.g. measured in Pa*ms). In some embodiments, impulse pressure (sometimes called detonation pressure) is measured with overpressure sensors.

As used herein, “specific impulse” means: an amount of force a material has per unit of time with respect to an amount of explosive used (e.g. measured in units of kPa*ms/kg). For example, the higher the impulse, the greater the blast/detonation of the blast media (e.g. fertilizer as measured at a distance of 7 m).

In some embodiments, specific impulse is utilized as a variable to express the characteristic of blast suppression (i.e. reduction, prevention, or elimination of a material's tendency to detonate/explode) for stabilizer materials in accordance with the various embodiments of the instant disclosure.

In some embodiments, the specific impulse of a fertilizer composition in accordance with the embodiments of the instant disclosure is less than the specific impulse of an ammonium nitrate fertilizer (e.g. where commercially available fertilizer has an ammonium nitrate content of about 98-100% AN).

Specific Impulse is calculated via the following formula:

Specific impulse=((Impulse_{Total}−Impulse_{Booster})/(I−Conc.)/Charge Mass

where Impulse_{Total} is the average measure of the pressure sensors (overpressure sensors), which is corrected for: (a) the booster (i.e. Impulse_{Booster}), (b) the mass of the charge (measured value), and (c) the % dilution (measured value).

In some embodiments (e.g. with reference to the blast tests completed in the Examples sections), as the blast components were prepared, there is some level of variability in the specific impulse values obtained for the “same” materials. Without being bound by a particular mechanism or theory, non-limiting examples of possible sources of variation include: variability in the packing of the materials, environment of testing, time of day of blast, mixing of the material, humidity, cloud cover, makeup of the fertilizer itself, and combinations thereof.

For example, without being bound by a particular mechanism or theory, variability in packing of the materials is believed to potentially result in varying amount of voids in different samples for the same material, which can result in different specific impulse values for the same materials (e.g. resulting in experimental variation and/or outliers).

In some embodiments, the specific impulse of a composition of the instant disclosure is: less than 13.5 kPa*ms/kg; less than 13 kPa*ms/kg; less than 12.5 kPa*ms/kg; less than 12 kPa*ms/kg; less than 11.5 kPa*ms/kg; less than 11 kPa*ms/kg; less than 10.5 kPa*ms/kg; less than 10 kPa*ms/kg; less than 9.5 kPa*ms/kg; less than 9 kPa*ms/kg; less than 8.5 kPa*ms/kg; less than 8 kPa*ms/kg; less than 7.5 kPa*ms/kg; less than 7 kPa*ms/kg; less than 6.5 kPa*ms/kg; less than 6 kPa*ms/kg; less than 5.5 kPa*ms/kg; less than 5 kPa*ms/kg; less than 4.5 kPa*ms/kg; less than 4 kPa*ms/kg; less than 3.5 kPa*ms/kg; less than 3 kPa*ms/kg; less than 2.5 kPa*ms/kg; less than 2 kPa*ms/kg; less than 1.5 kPa*ms/kg; or less than 1 kPa*ms/kg.

In some embodiments, the specific impulse of a composition of the instant disclosure is: less than 1 kPa*ms/kg; less than 0.8 kPa*ms/kg; less than 0.6 kPa*ms/kg; less than 0.5 kPa*ms/kg; less than 0.4 kPa*ms/kg; less than 0.2 kPa*ms/kg; less than 0.1 kPa*ms/kg; less than 0.05 kPa*ms/kg; or less than 0.01 kPa*ms/kg.

In some embodiments, the specific impulse of a composition of the instant disclosure is: not greater than 13.5 kPa*ms/kg; not greater than 13 kPa*ms/kg; not greater than 12.5 kPa*ms/kg; not greater than 12 kPa*ms/kg; not greater than 11.5 kPa*ms/kg; not greater than 11 kPa*ms/kg; not greater than 10.5 kPa*ms/kg; not greater than 10 kPa*ms/kg; not greater than 9.5 kPa*ms/kg; not greater than 9 kPa*ms/kg; not greater than 8.5 kPa*ms/kg; not greater than 8 kPa*ms/kg; not greater than 7.5 kPa*ms/kg; not greater than 7 kPa*ms/kg; not greater than 6.5 kPa*ms/kg; not greater than 6 kPa*ms/kg; not greater than 5.5 kPa*ms/kg; not greater than 5 kPa*ms/kg; not greater than 4.5 kPa*ms/kg; not greater than 4 kPa*ms/kg; not greater than 3.5 kPa*ms/kg; not greater than 3 kPa*ms/kg; not greater than 2.5 kPa*ms/kg; not greater than 2 kPa*ms/kg; not greater than 1.5 kPa*ms/kg; or not greater than 1 k: Pa*ms/kg.

In some embodiments, the specific impulse of a composition of the instant disclosure is: not greater than 1 k:Pa*ms/kg; not greater than 0.8 k:Pa*ms/kg; not greater than 0.6 k:Pa*ms/kg; not greater than 0.5 k:Pa*ms/kg; not greater than 0.4 k:Pa*ms/kg; not greater than 0.2 kPa*ms/kg; not greater than 0.1 k:Pa*ms/kg; not greater than 0.05 k:Pa*ms/kg; or not greater than 0.01 kPa*ms/kg.

As used herein, “desensitization” means: the reduction in the critical energy of detonation of a material. As a non-limiting example, desensitization results in a material's reduced ability or inability to explode, when given a donor charge (i.e. booster) or when impacted from a fragment. In some embodiments, desensitization is characterized via unconfined critical diameter of the fertilizer composition. In some embodiments, desensitization is quantified by the booster quantity needed to cause an explosion (i.e. or a non-explosive event at a large quantity of booster size).

As used herein, “unconfined critical diameter” means a minimum diameter that a given volume of explosive material must be in, in order to sustain a detonation front (i.e. explode). In some embodiments, unconfined critical diameter is a variable which is used to measure whether a particular stabilizer material or combination of stabilizer materials have the ability to desensitize an ANFO-type material from detonating/exploding.

In some embodiments, when compared to AN fertilizers, fertilizer compositions of the instant disclosure are “desensitized” by: at least a factor of two; at least a factor of three; at least a factor of four; at least a factor of five; at least a factor of six; at least a factor of seven; at least a factor of eight; at least a factor of nine; or at least a factor of ten.

In some embodiments, when compared to AN fertilizers, fertilizer compositions of the instant disclosure are “desensitized” by: not greater than a factor of two; not greater than a factor of three; not greater than a factor of four; not greater than a factor of five; not greater than a factor of six; not greater than a factor of seven; not greater than a factor of eight; not greater than a factor of nine; or not greater than a factor of ten.

As used herein, “detonation” means a supersonic exothermic front accelerating through a medium that eventually drives a shock front propagating from it (i.e. directly in front of it).

As used herein, “ammonium nitrate material” (also interchangeably referred to as AN) means: a composition including ammonium nitrate (NH₄NO₃). In some embodiments, ammonium nitrate is used in agriculture as a high-nitrogen fertilizer, though AN fertilizer can also be used as an oxidizing agent in explosives (e.g. including improvised explosive devices).

As used herein, “stabilizer material” means: a material added to another material to prevent or retard an unwanted alteration of physical state. In some embodiments, a stabilizer material is present with an ammonium nitrate material to provide a fertilizer composition which prevents or retards an unwanted oxidation/explosion of the composition. In some embodiments, the stabilizer material comprises an additive.

As used herein, “additive” means: a substance added to another in defined amounts to effect a desired change in one or more properties. In accordance with the instant disclosure, an additive is added to a fertilizer comprising ammonium nitrate in order to prevent, reduce, or eliminate the ability of the composition to be utilized as a material (e.g. oxidizing material) in an explosive and/or explosive device.

In some embodiments, the presence of a stabilizer material in the fertilizer composition (i.e. at a particular wt. %) prevents the composition from exploding (i.e. when measured in accordance with a blast propagation test). In other embodiments, the presence of a stabilizer material in the fertilizer composition (i.e. at a particular wt. %) reduces the specific impulse of the composition.

As used herein, “explosive device” means: a device that provides for a sudden, loud, and violent release of energy that happens when the device (or material therein) breaks apart in such a way that sends parts flying outward. Non-limiting examples of explosive devices include bombs and/or improvised explosive devices.

As used herein, “booster” means: an auxiliary device for increasing force, power, pressure, or effectiveness. In some embodiments, booster refers to the portion of the blast propagation test that initializes the blast. In some embodiments, the booster in the blast propagation test includes C4 explosive,

As used herein, “detonation” means: the act or process of exploding or causing something to explode. In some embodiments, one or more stabilizer materials of the instant disclosure effect a reduction in or elimination of the detonation of ammonium nitrate material (e.g. utilized in an explosive device as an oxidizing material).

As used herein, “suppressant” means: an agent that tends to prevent, control, or reduce the intensity of a particular property of a material. In some embodiments, suppressant effects are quantified by measuring a reduction in specific impulse of a fertilizer composition, as compared to control (commercially available AN or AN fertilizer). In some embodiments, suppressant refers to a chemical mechanism of blast inhibition and/or prevention.

As used herein, “diluent” means: a diluting agent. In some embodiments, the stabilizer materials to the ammonium nitrate act as filler, thinning out the proximity of particles of ammonium nitrate from one another. In some embodiments, diluent refers to a mechanical mechanism of blast inhibition and/or prevention (i.e. dilution by addition of stabilizer material which acts as a filler material).

As used herein, “substantially non-reactive” means: dimensionally stable. In some embodiments, substantially non-reactive means inert (non-reacting). Some non-limiting examples of substantially non-reactive stabilizer materials include: sand, clay (i.e. naturally occurring and/or synthetic clays), aggregate, and the like

As used herein, “bauxite residue” means: particulate alkaline clay produced as a byproduct of the Bayer Process (e.g. the process of refining of bauxite ore into alumina). In some embodiments, bauxite residue (sometimes called red mud) includes a plurality of metals, metal oxides, clay, and zeolites. In some embodiments, the bauxite residue is generally free from draining liquids and is neutralized from its original form (i.e. slurry having volatile components at a pH of approximately 13).

As used herein, “dawsonite” means: a sodium aluminate carbonate hydroxide compound. In some embodiments, dawsonite is a byproduct of the refining step(s) (e.g. after addition of sodium hydroxide in the Bayer Process).

As used herein, “fukalite” means: a calcium silicate carbonate compound. In some embodiments, fukalite is a hydroxide or a fluoride derivative of a calcium silicate carbonate compound. In some embodiments, fukalite is a byproduct of the refining step(s) (e.g. after addition of sodium hydroxide in the Bayer Process).

In some embodiments, dawsonite, fukalite, hydroxyapatite, and hydroxymagnesite are components in bauxite residue. In some embodiments, dawsonite, fukalite, hydroxyapatite, and hydroxymagnesite are components in bauxite.

As used herein, “ESP” means the dust that comes from an electrostatic precipitator (i.e. used to clean industrial process exhaust streams). In some embodiments, ESP comprises (e.g. as a major component) alumina fines which are removed from exhaust fumes of industrial processes.

As used herein, “bauxite” means: an ore from which alumina is extracted. In some embodiments, bauxite ore can comprise aluminium oxide, aluminium hydroxide, aluminium oxyhydroxide iron oxides, silicates, calcium carbonate, sodium hydroxide, calcium oxide, titania, manganese oxide, magnesium oxide, phosphates. In some embodiments, bauxite comprises at least 30 wt. % alumina; at least 40 wt. % alumina; at least 50 wt. % alumina; at least 60 wt. % alumina; at least 70 wt. %; at least 80 wt. %; at least 90 wt. %, or higher.

As used herein, “binder” means: a material that is used to hold things together. As some non-limiting examples, embodiments of binders include: waste from paper mills, sugars, polymers, starches, water, guar gum, clays (e.g. bentonite), sodium silicates, and combinations thereof.

Where the stabilizer material comprises two components, for example, huntite and hydromagnesite, or huntite and an apatite or magnesite and an apatite, the two components may be provided in any ratio, including but not limited to 1:9, 2:8, 3:7, 4:6, 5:5, 6:4, 7:3, 8:2 or 9:1.

Where the stabilizer material comprises huntite and an apatite, the huntite and the apatite may be provided in a ratio of 1:1. This does not preclude the inclusion of other components in the stabilizer material and is an indication only of the ratio of the huntite and the apatite.

Where the stabilizer material comprises magnesite and an apatite, the huntite and the apatite may be provided in a ratio of 1:1. This does not preclude the inclusion of other components in the stabilizer material and is an indication only of the ratio of the magnesite and the apatite.

Where the stabilizer material comprises three or more components, the three or more components may be provided in any ratio. For example, where the stabilizer material comprises huntite, hydromagnesite and calcium carbonate, these materials may be provided in a ratio of approximately 1:1:1.

Without being bound by a particular mechanism or theory, it is believed that in one potential pathway, certain stabilizer materials may act as suppressants, causing a chemical inhibition of ammonium nitrate, thus preventing it from being utilized as an oxidizing material in an explosive device.

Without being bound by a particular mechanism or theory, it is believed that in another potential pathway, certain stabilizer materials may act as diluents, causing a mechanical inhibition of ammonium nitrate, thus preventing it from being utilized as an oxidizing material in an explosive device.

Without being bound by a particular mechanism or theory, it is believed that in yet another pathway, certain stabilizer materials may act as carbonating agents, such that carbon dioxide produced by the stabilizer material replaces/excludes oxygen needed for an explosion to continue/propagate, thus resulting in no increase in energy (needed to propagate the explosion).

Without being bound by a particular mechanism or theory, it is believed that in yet another pathway, certain stabilizer materials may act as hydrates, such that during an explosion event (increase in energy) the stabilizer material produces water vapour, which also acts to exclude oxygen or quench heat coming from the reaction so that resulting exothermic energy is reduced (and the material does not explode), thermal moderators.

Without being bound by a particular mechanism or theory, it is believed that in yet another pathway, certain stabilizer materials may act in accordance with an acid/base mechanism, such that the stabilizer material is basic or releases a base when at reaction conditions thus preventing ammonium nitrate from proceeding to nitric acid (thus the reaction will not proceed or take place). In some embodiments, the stabilizer material(s) act as a thermal moderator to adsorb energy, thus reducing the explosive force. In some embodiments, the stabilizer materials act as oxygen displacers by pushing out oxygen and replace the gas with a non-combustible (e.g. CO₂).

Without being bound by a particular mechanism or theory, in some embodiments a stabilizer material is added to the fertilizer, where the chemical species in the stabilizer material acts to absorb some of the energy released if the fertilizer is used in ammonium nitrate fuel oil (ANFO) improvised explosive devices or other ammonium nitrate fuel combinations used for explosives. Specifically, in this potential mechanistic pathway, the chemical stabilizer materials are believed to absorb a portion of the heat released during ammonium nitrate-fuel detonations such that the stabilizer materials reduce the final equilibrium temperature of the system via both sensible heat absorption and endothermic chemical reactions. Along with the energy absorption property, the presence of stabilizer material solid particles is believed to reduce the energy density of the mixture via dilution of the filler material.

In some embodiments, the fertilizer composition includes a plant nutrient. Non-limiting examples of plant nutrients include: N, P, K, Mg, Ca, K, trace elements (Fe, Mn, metals present in the stabilizer material compounds), and combinations thereof.

These and other aspects, advantages, and novel features of the technology are set forth in part in the description that follows and will become apparent to those skilled in the art upon examination of the following descriptions and Figures, or is learned by practicing the embodiments of the instant disclosure.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 depicts a schematic of an embodiment of a blast test article in accordance with the instant disclosure;

FIG. 2 depicts a schematic cut-away side view of the blast test article of FIG. 1, depicting the booster and fertilizer composition to be tested;

FIG. 3 is a chart depicting % blast suppression;

FIG. 4 is a chart depicting % blast suppression;

FIG. 5 is a chart depicting % blast suppression; and

FIG. 6 is a chart depicting % blast suppression;

### DESCRIPTION OF EMBODIMENTS

Throughout this specification, unless the context requires otherwise, the word “comprise” or variations such as “comprises” or “comprising”, will be understood to imply the inclusion of a stated integer or group of integers but not the exclusion of any other integer or group of integers.

### EXAMPLE

### Standard Operating Procedure for Blast Tests

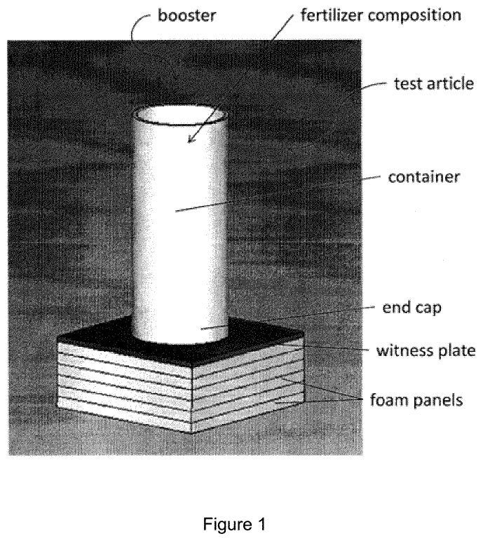

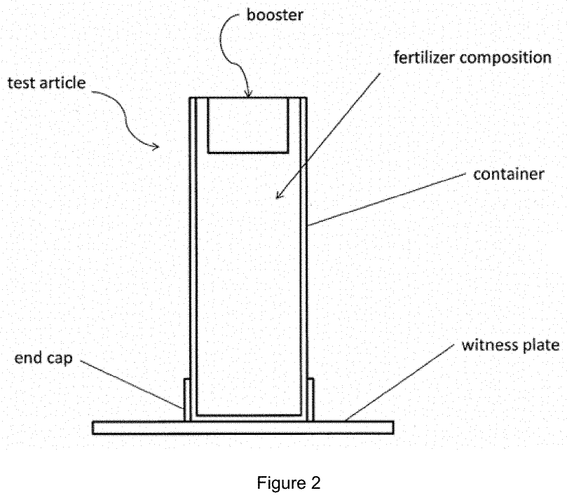

Test articles refer to the container (PVC pipe or bucket), a mild steel plate (called a witness plate), fertilizer composition (stabilizer material and AN mixed with 6 wt. % or 12 wt. % fuel oil of AN), and a booster (includes C4 explosive in a plastic storage cup). A schematic of a test article is depicted in FIG. 1, while the innards of each test article, including the detonator, booster, and fertilizer composition are shown in FIG. 2.

The chemistry of ANFO detonation is the reaction of ammonium nitrate with a long chain alkane (CₙH₂ₙ₊₂) (usually diesel oil) to form nitrogen, carbon dioxide and water. For an ideal stoichiometrically balanced reaction, ANFO requires 94.3% AN and 5.7% FO. In practice, a slight excess of fuel oil is added (6% is standard), as underdosing results in reduced blast. Overdosing does not result in increased or decreased blast but merely more post-blast fumes.

Samples labelled 12 wt. % fuel oil were samples of ANFO with an additional 6 wt. % fuel oil added. The results for these samples were normalised to reflect a composition with 94 wt. % AN.

### Sample Preparation:

To make a fertilizer composition for the test article, ANFO prills were dry blended with the stabilizer material powder for at least 20 minutes.

Each test article was weighed empty using a scale with an accuracy of +/−0.2 grams. The resulting mixture was added to each container (PVC with glued end cap or bucket) to within 25 mm of top edge. Each filled test article (ammonium nitrate and stabilizer material, mixed with fuel oil) was weighed on a scale having an accuracy of +/−0.1 ounce.

Each test article was left to stand with a covering (e.g. plastic bag) applied to prevent ambient moisture from entering the test article. Just prior to testing, the booster (C4 in a plastic cup or bucket) was inserted flush with the top of the pipe, with the detonator wire attached to the booster.

Boosters for each test article were prepared in small plastic storage cups. A predetermined amount of C4 was measured into each cup. A C4 booster was added to a 8″ diameter tube with blast material to be tested. The total weight of the tube was approximately eight kg (including the blast material).

Each test article included a 0.25 inch thick mild steel plate (called a witness plate), with a PVC Pipe, base/end cap or PVC bucket. The test article was placed onto a 4½″ stack thick piece of foam (12 inches×12 inches) on a level sand pit.

Filled test articles were placed onto witness plates and positioned and centred on the witness plate. Cable (Cat6 cable) was routed from the shelter to Over Pressure probes.

The detonator was placed into the booster, the charge was armed, and the booster was detonated. For each test article, the detonator was Exploding Bridge Wire (EBW) Type RP-83.

Blast suppression was measured via two blast pressure probes (PCB model), positioned at a distance of 7 m from the test article. Coaxial cable ran from each probe (2 channel, 12 bit, IEPE, 100 kHz) to a computer. Steel rods were positioned between the probes and the target (i.e. test article) to deflect any possible shrapnel.

For each test, two blast pressure probes were used to measure the pressure versus time of each explosion (kPa*ms). The resulting pressure readings were used to compute the specific impulse of the fertilizer composition for each test article. Blast overpressure (i.e. impulse pressure) was collected for each test article.

This data was integrated by standard means and divided by the amount of ammonium nitrate present to generate a “specific impulse” (i.e. maximum pressure reading for each blast test impulse). These were measured against a reference specific impulse of ANFO.

Without being bound by a particular mechanism or theory, stabilizer materials with a specific impulse at approximately the same level as the baseline (AN controls) are considered “inert”, in that it is believed that these materials affect the impulse at the same levels as the concentration dictates (i.e. operate by a mechanical “filler” mechanism).

Without being bound by a particular mechanism or theory, measurements below the baseline results are considered “suppressants”, in that it is believed that these materials affect the impulse by a chemical reaction or mechanism independent, or in combination with, a dilution factor.

Blast suppression results on a number of additives were collected and analysed. All the materials tested acted as blast suppressants, and performed as well as or better than the industry standards. The additives were magnesite and a number of hydromagnesite/huntite blends the constitution of which is provided below:
Composite A: 66 wt. % huntite, 31 wt. % hydromagnesite, 3 wt. % calcium carbonate;
Composite B: 71 wt. % huntite, 4 wt. % hydromagnesite, 25 wt. % calcium carbonate;
Composite C: 81 wt. % huntite, 2 wt. % hydromagnesite, 17 wt. % calcium carbonate;

To determine the relationship between the blast suppression and percentage additive added to the ammonium nitrate, the data is fitted using a logistic function model or an “S-curve” function:

$$y = \frac{C}{1 + {Ae}^{- Bx}}$$

Where C is the maximum value (max suppression) and A and B are factors that affect the slope and mid-point respectively. This is a common treatment for fitting data and is not specific to blast suppression science. The factors are adjusted to get the best fit (measured by the R2 value) using the raw experimental data.

In order to identify stabilizer materials with blast suppression and/or desensitization characteristics, the various stabilizer materials were tested (at different wt. %), in a 8″ diameter tube with 200 g booster. The specific impulse was calculated for each test article and the reduction in specific impulse relative to ammonium nitrate with no stabilizer was calculated.

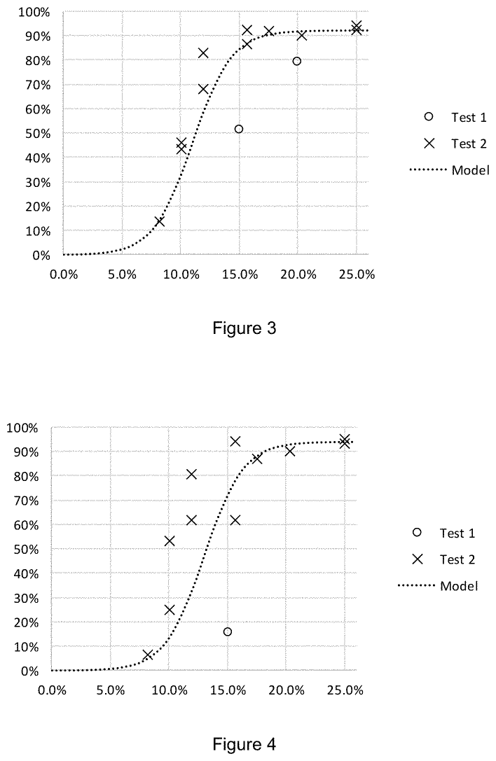

FIG. 3 presents blast test results for Composite A. Tests were conducted using 6 wt. % fuel oil (Test 1) and 12 wt. % fuel oil (Test 2). The results were combined and modelled.

FIG. 4 presents blast test results for Composite B. Tests were conducted using 6 wt. % fuel oil (Test 1) and 12 wt. % fuel oil (Test 2). The results were combined and modelled.

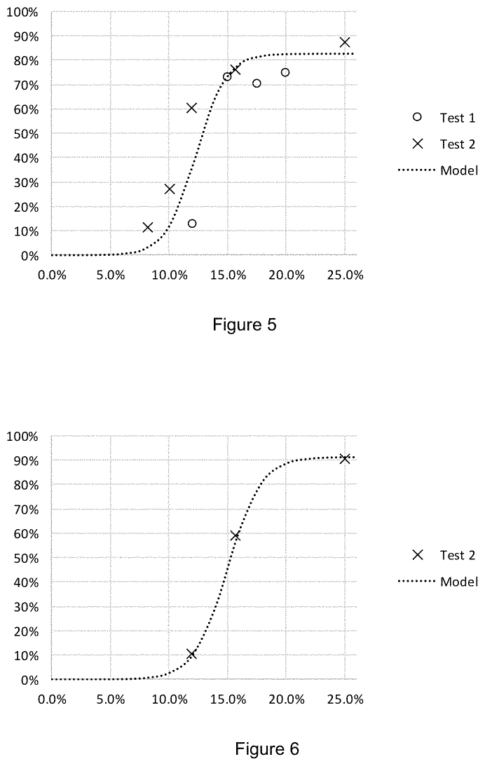

FIG. 5 presents blast test results for Composite C. Tests were conducted using 6 wt. % fuel oil (Test 1) and 12 wt. % fuel oil (Test 2). The results were combined and modelled.

FIG. 6 presents blast test results for magnesite. Tests were conducted using 12 wt. % fuel oil.

Various ones of the inventive aspects noted herein above may be combined to yield fertilizer compositions and methods of making and using the same to fertilize soil, while preventing, reducing, or eliminating the fertilizer (AN fertilizer) from being used in explosives and/or improvised explosive devices.

While various embodiments of the instant disclosure have been described in detail, it is apparent that modifications and adaptations of those embodiments will occur to those skilled in the art. However, it is to be expressly understood that such modifications and adaptations are within the spirit and scope of the instant disclosure.

1. A fertilizer composition comprising an ammonium nitrate material and an effective amount of a stabilizer material to result in a specific impulse reduction of at least 50% when compared the specific impulse of a commercially available ammonium nitrate composition;
wherein the stabilizer material comprises at least one of huntite and magnesite; and
wherein the stabilizer material is at least 10 wt. % of the total fertilizer composition.

2. The fertilizer composition of claim 1, wherein the stabilizer material comprises huntite.

3. The fertilizer composition of claim 2, wherein the stabilizer material is from 10 wt. % to 25 wt. % of the total fertilizer composition.

4. The fertilizer composition of claim 3, wherein the stabilizer material further comprises hydromagnesite.

5. The fertilizer composition of claim 4, wherein the stabilizer material comprises from 1 wt. % to 40 wt. % hydromagnesite.

6. The fertilizer composition of claim 3, wherein the stabilizer material further comprises calcium carbonate.

7. The fertilizer composition of claim 3, wherein the stabilizer material comprises huntite, hydromagnesite and calcium carbonate.

8. The fertilizer composition of claim 3, wherein the stabilizer material comprises at least 50 wt. % huntite.

9. The fertilizer composition of claim 3, wherein the stabilizer material comprises from 50 wt. % to 90 wt. % huntite.

10. The fertilizer composition of claim 1, wherein the stabilizer material comprises magnesite.

11. A method comprising:
combining an ammonium nitrate material with an effective amount of a stabilizer material to result in a fertilizer composition with specific impulse of at least 50% less than the specific impulse of a commercially available ammonium nitrate composition;
wherein the stabilizer material comprises at least one of huntite and magnesite; and
wherein the stabilizer material is about 10 to about 25 wt. % of the total fertilizer composition.

12. The method of claim 11, wherein the stabilizer material further comprises hydromagnesite.

13. The method of claim 11, wherein the stabilizer material further comprises calcium carbonate.

14. The method of claim 11, wherein the stabilizer material comprises huntite, hydromagnesite and calcium carbonate.

15. The method of claim 11, wherein the stabilizer material comprises at least 50% huntite.

16. The method of claim 11, wherein the stabilizer material comprises magnesite.
